(19) United States
(12) Patent Application Publication
(10) Pub. No.: US 2017/0365084 A1
(43) Pub. Date: Dec. 21, 2017

(54) IMAGE GENERATING APPARATUS AND IMAGE GENERATING METHOD

(71) Applicant: FUJITSU LIMITED, Kawasaki-shi (JP)

(72) Inventor: Naoko Hayashida, Kawasaki-shi (JP)

(73) Assignee: FUJITSU LIMITED, Kawasaki-shi (JP)

(21) Appl. No.: 15/620,043

(22) Filed: Jun. 12, 2017

(30) Foreign Application Priority Data
Jun. 15, 2016 (JP) 2016-119248

(51) Int. Cl. G06T 13/40; G02B 27/01; G06K 9/00; G06F 3/01

(52) U.S. Cl. CPC G06T 13/40; G06F 3/017; G06F 3/011; G02B 27/0172; G06K 9/00201; G02B 2027/0178; G02B 27/0179; G06T 2200/04; G06T 2219/024

(57) ABSTRACT

An image generating apparatus includes memory and processors programed to execute a process including acquiring first data indicating a position of a body portion of a predetermined person being sensed at first timing, generating a first image having the position of the body portion indicated by the first data reflected in an avatar representing the predetermined person, acquiring second data indicating a position of the body portion of the predetermined person being sensed at second timing, determining whether to reflect the position of the body portion of the body indicated by the second data in the avatar according to change in movement of the predetermined person from the first to the second data, and outputting a second image having the position of the body portion indicated by the second data reflected in the avatar when determined to reflect the position of the body portion indicated by the second data.

### CROSS-REFERENCE TO RELATED APPLICATION

This patent application is based upon, and claims the benefit of priority of Japanese Patent Application No. 2016-119248 filed on Jun. 15, 2016, the entire contents of which are incorporated herein by reference.

### FIELD

The embodiments discussed herein relate to an image generating apparatus and image generating method.

### BACKGROUND

In communications in real space, analyzing reactions of other people (e.g., communication counterpart persons) with respect to non-verbal behaviors of a person (e.g., intersections of gaze, physical closeness, body gesture and hand gesture, smile, etc.,) may be of importance in order to estimate a balance of intimacy in human relationships and the like.

In virtual reality space, communications are held between users via respective avatars. In order to estimate mutual human relations in virtual reality space, it is necessary for an image generating apparatus to accurately sense non-verbal behaviors of a user in real space to generate an avatar image having a sensing result reflected as closely as possible.

When the sensing result that includes an error or the like are reflected in an avatar, such an avatar gives wrong impression to other users (e.g., communication counterpart persons) who see the image of the avatar. As a result, balance of intimacy in human relations may change.

One aspect of an object of the present invention is to generate an image that does not give wrong impression to a person who sees an avatar.

### RELATED ART DOCUMENT

### Patent Document

Patent Document 1: Japanese National Publication of International Patent Application No. 2012-528398

### SUMMARY

According to an aspect of the embodiments, an image generating apparatus includes a memory and one or more processors programed to execute a process. The process includes acquiring first data indicating a position of a body part of a predetermined person obtained as a result of sensing the predetermined person at a first timing; generating a first image having the position of the body part of the predetermined person indicated by the first data reflected in an avatar representing the predetermined person; acquiring second data indicating a position of the body part of the predetermined person obtained as a result of sensing the predetermined person at a second timing after the first timing; determining whether to reflect the position of the body part of the predetermined person indicated by the second data in the avatar representing the predetermined person according to a change in movement of the predetermined person from the first data to the second data; and outputting, instead of the first image, a second image having the position of the body part of the predetermined person indicated by the second data reflected in the avatar representing the predetermined person when it is determined to reflect the position of the body part of the predetermined person indicated by the second data in the avatar representing the predetermined person.

The object and advantages of the invention will be realized and attained by means of the elements and combinations particularly pointed out in the appended claims.

It is to be understood that both the foregoing general description and the following detailed description are exemplary and explanatory and are not restrictive of the invention.

Additional objects and advantages of the embodiments will be set forth in part in the description which follows, and in part will be obvious from the description, or may be learned by practice of the invention.

### BRIEF DESCRIPTION OF THE DRAWINGS

FIG. 1 is a first diagram illustrating an example of an overall configuration of an image generating system;

FIG. 2 is a diagram illustrating an example of a virtual reality space image;

FIG. 3 is a diagram illustrating a method of representing an avatar image;

FIG. 4 is a diagram illustrating an example of a hardware configuration of an image generating apparatus;

FIG. 5 is a diagram illustrating an example of a hardware configuration of an HMD on which an information processing apparatus is implemented;

FIGS. 6A and 6B are first diagrams illustrating a functional configuration of a restricting unit of the image generating apparatus;

FIGS. 7A to 7C are diagrams illustrating examples of sensor data stored in a sensor data DB;

FIGS. 8A and 8B are diagrams illustrating an example of from-to rotation angle transition definition information stored in a definition information DB;

FIG. 9 is a first flowchart illustrating an avatar skeleton model updating process;

FIG. 10 is a diagram illustrating an example of a determination value log DB table stored in a log DB;

FIG. 11 is a diagram illustrating an example of an avatar body bone log DB table stored in the log DB;

FIGS. 12A and 12B are second diagrams illustrating a functional configuration of a restricting unit of the image generating apparatus;

FIG. 13 is a diagram illustrating an example of API definition information stored in the definition information DB;

FIG. 14 is a diagram illustrating an example of tendency definition information stored in the definition information DB;

FIG. 15 is a second flowchart illustrating an avatar skeleton model updating process;

FIG. 16 is a third flowchart illustrating an avatar skeleton model updating process;

FIG. 17 is a diagram illustrating an example of a social behavior log DB table stored in the log DB;

FIGS. 18A and 18B are third diagrams illustrating a functional configuration of a restricting unit of the image generating apparatus;

FIG. 19 is a diagram illustrating an example of combination condition definition information stored in the definition information DB;

FIGS. 20A and 20B are diagrams illustrating conditions to be combined;

FIG. 21 is a fourth flowchart illustrating an avatar skeleton model updating process;

FIG. 22 is a fifth flowchart illustrating an avatar skeleton model updating process;

FIGS. 23A and 23B are fourth diagrams illustrating a functional configuration of a restricting unit of the image generating apparatus;

FIG. 24 is a diagram illustrating an example of area information stored in the definition information DB;

FIG. 25 is a second diagram illustrating an example of an overall configuration of an image generating system;

FIG. 26 is a diagram illustrating an example of an analysis result by an analyzer; and

FIGS. 27A and 27B are diagrams illustrating a functional configuration of the analyzer of the image generating apparatus.

### DESCRIPTION OF EMBODIMENTS

The following illustrates embodiments with reference the accompanying drawings. Note that, in the description and the figures, the same reference numerals are repeatedly used to describe substantially the same elements and repeated descriptions thereof may be omitted.

### First Embodiment

### Overall Configuration of Image Generating System

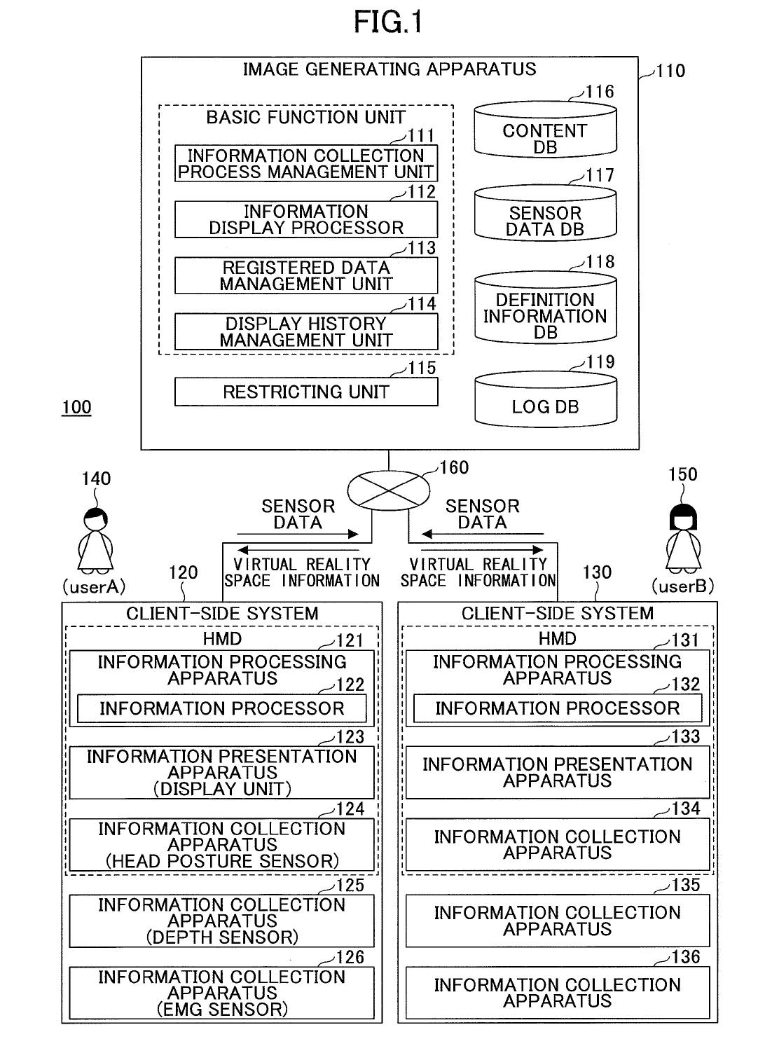

First, an image generating system is described. FIG. 1 is a first diagram illustrating an example of an overall configuration of the image generating system. As illustrated in FIG. 1, the image generating system 100 includes an image generating apparatus 110 having server software allocated, and client-side systems 120 and 130 including information processing apparatuses 121 and 131 each having client application software allocated. The image generating apparatus 110 and the client-side systems 120, 130 are connected via a network 160 typically represented by the Internet, LAN (Local Area Network), or the like.

The image generating system 100 includes the image generating apparatus 110 and the client-side systems 120 and 130 that divide functions of an entire process to execute the divided functions so as to provide a communication service. A user 140 (user ID=“user A”) and a user 150 (user ID=“user B”) use the communication service provided by the image generating system 100 at locations separated from each other. As a result, the user 140 and the user 150 may be able to communicate via respective avatars (images associated with users) in the same virtual reality space.

The image generating apparatus 110 is a server apparatus configured to collect sensor data obtained as a result of sensing the users 140 and 150 to perform various processes.

The image generating apparatus 110 has installed an image generating program as server software, and the image generating apparatus 110 serves as a basic function unit and a restricting unit 115 upon execution of the image generating program.

The basic function unit includes an information collection process management unit 111, an information display processor 112, a registered data management unit 113, and a display history management unit 114 to implement basic functions for providing a communication service.

The information collection process management unit 111 is configured to collect sensor data obtained as a result of sensing the users 140 and 150, and store the collected sensor data in a sensor data database (hereinafter abbreviated as “DB”) 117.

The information display processor 112 is configured to generate an avatar image in virtual reality space based on the sensor data stored in the sensor data DB 117. For example, the information display processor 112 generates an avatar image using an avatar skeleton model stored in a content DB 116. The avatar skeleton model is a humanoid image that represents a movement (motion) of each part of the user using multiple avatar body bones. Note that an avatar body bone is an object that serves as a base point for moving the avatar's head or limbs, and multiple avatar body bones are allocated to an avatar skeleton model. The information display processor 112 is configured to calculate a position and a rotation angle in virtual reality space for each avatar body bone, and to reflect the calculated position and rotation angle in the avatar skeleton model, thereby generating an image of the avatar.

The information display processor 112 is configured to generate virtual reality space information by incorporating an image of the avatar in an image of virtual reality space (background image) stored in the content DB 116, and transmits the generated virtual reality space information to the client-side systems 120 and 130.

Note that the information display processor 112 changes the image of the avatar to be incorporated in the virtual reality space image based on an instruction from the restricting unit 115. For example, when the information display processor 112 receives from the restricting unit 115 an instruction to display an avatar image at a next clock time generated by the information display processor 112, the information display processor 112 incorporates the avatar image at the next clock time generated by the information display processor 112 to generate a virtual reality space image at the next clock time. When the restricting unit 115 determines that the image of the avatar of the next clock time does not give wrong impression to a counterpart person who sees the avatar, the restricting unit 115 instructs the information display processor 112 to display the avatar image at the next clock time generated by the information display processor 112.

When the information display processor 112 receives from the restricting unit 115 an instruction to display an avatar image at a next clock time generated by the restricting unit 115, the information display processor 112 incorporates the avatar image at the next clock time generated by the restricting unit 115 to generate a virtual reality space image at the next clock time. Note that when the restricting unit 115 determines that the avatar image at the next clock time gives wrong impression to a counterpart person who sees the avatar, the restricting unit 115 instructs the information display processor 112 to display the avatar image at the next clock time generated by the information display processor 115.

The registered data management unit 113 is configured to register, in the content DB 116 and the definition information DB 118, various kinds of information used when the information collection process management unit 111 collects sensor data, and used when the information display processor 112 generates virtual reality space information and transmits the generated virtual reality space information.

The display history management unit 114 is configured to record, in the log DB 119, the data used for generating the avatar image included in virtual reality space information transmitted by the information display processor 112 as a log DB table relating to a display history. The administrator of the image generating apparatus 110 analyzes the log DB table relating to the display history recorded in the log DB 119 by the display history management unit 114 so as to infer a human relationship (e.g., balance of intimacy) between the users 140 and 150.

The restricting unit 115 is configured to monitor a change of each avatar body bone of the avatar skeleton model candidate calculated on the basis of the sensor data stored in the sensor data DB 117 and determines whether the displayed avatar gives wrong impression to the counterpart person who sees the avatar. The “change of an avatar body bone” refers to transition in position and rotation angle between an avatar body bone at a certain clock time in virtual reality space and an avatar body bone at a next clock time.

When the restricting unit 115 determines that the displayed avatar does not give wrong impression to the counterpart person who sees the avatar, the restricting unit 115 instructs the information display processor 112 to display an avatar image at a next clock time generated by the information display processor 112.

When the restricting unit 115 determines that the displayed avatar does give wrong impression to the counterpart person who sees the avatar, the restricting unit 115 instructs the information display processor 112 to display an avatar image at a next clock time generated by the restricting unit 115 (i.e., the avatar image with restriction).

As described above, in the image generating apparatus 110 according to the first embodiment, when it is determined that the displayed avatar does not give wrong impression to the counterpart person who sees the avatar, the avatar image based on the sensor data is displayed at a next clock time. By contrast, when it is determined that the displayed avatar gives wrong impression to the counterpart person who sees the avatar, the avatar image to which the restriction is added is displayed at the next clock time. As a result, the image generating apparatus 110 in the first embodiment may be able to display an image that does not give wrong impression to the counterpart person who sees the avatar.

Next, a description is given of the client-side systems. Since the client-side system 120 and the client-side system 130 have the same configuration, the client-side system 120 will be described below.

The client-side system 120 includes an information processing apparatus 121, an information presentation apparatus 123, and information collection apparatuses 124 to 126.

The information processing apparatus 121 has installed an information processing program as a client application, and the information processing apparatus 121 will function as an information processor 122 by the execution of the information processing program. The information processor 122 is configured to transmit the sensor data that are output from the information collection apparatuses 124 to 126 to the image generating apparatus 110, and receive information for virtual reality space transmitted from the image generating apparatus 110 to output the received information for virtual reality space to the information presentation apparatus 123.

Note that in the first embodiment, the information processing apparatus 121 is described as being implemented on an HMD (Head-Implemented Display); however, the information processing apparatus 121 may not be implemented on the HMD. For example, the information processing apparatus 121 may be implemented on an environment-embedded terminal that surrounds the user 140. Alternatively, the information processing apparatus 121 may be implemented on a wearable mobile terminal such as a contact lens or eyeglasses, a stand-alone server apparatus, or the like.

The information presentation apparatus 123 is configured to display, to the user 140, the virtual reality space information transmitted from the image generating apparatus 110. Note that in the first embodiment, the information presentation apparatus 123 is implemented as a display of the HMD.

The information collection apparatuses 124 to 126 sense non-verbal behaviors in real space of the user 140 and output sensor data.

In the first embodiment, the information collection apparatus 124 serves as a head posture sensor that is implemented on the HMD. The head posture sensor 124 is configured to sense “head orientation” included in non-verbal behavior in real space of the user 140 and outputs head posture data.

In the first embodiment, the information collection apparatus 125 is a depth sensor. The depth sensor 125 is installed in front of the user 140; the depth sensor 125 is configured to sense a three-dimensional distance from an position of the depth sensor 125 to a position of the user 140 to output depth data, a two-dimensional depth image and the like that change according to non-verbal behaviors of the user 140 in real space. The depth data indicate a depth (e.g., 3 cm). The depth image is an image obtained by plotting the depth data acquired from the depth sensor 125 in an XY plane. For each pixel on the depth image, a value of the distance from the user to an object (the frontmost object viewed from the depth sensor 125) at respective XY coordinate positions acquired from the depth sensor 125 is stored. Note that data obtained from the depth sensor 125 (including depth data, depth image, color image, etc.,) are collectively referred to as depth sensor data.

In the first embodiment, the information collection apparatus 126 is a myoelectricity (EMG) sensor. The EMG sensor 126 is configured to sense a “change in facial expression” included in the non-verbal behavior in real space of the user 140 and outputs myoelectricity (EMG) data.

In the following description, it is assumed that one user is allocated to one apparatus (information processing apparatus) to which client application software is allocated; however, two or more users may be allocated to one apparatus.

In the following description, both the server software and the client application software are described as each being allocated to a corresponding one of apparatuses (the image generating apparatus and information processing apparatus); however, two or more software components may be allocated to each of the apparatuses. Alternatively, the server software and client application software may be allocated to a single apparatus. Alternatively, the server software and the client application software that implement respective functions may each be allocated to two or more apparatuses.

In the following description, it is assumed that the client application software identifies the user 140 and converts the virtual reality space information transmitted from the image generating apparatus 110 into virtual reality space information corresponding to the identified user 140 to display the converted virtual reality space information. In the following description, it is assumed that the sensor data obtained as a result of sensing the non-verbal behavior of the user 140 is transmitted to the image generating apparatus 110 in association with the user 140. It is assumed that the information processing apparatus 121 to which the client application software is allocated is access controlled by the client application software or server software. That is, in the following description, it is assumed that the person identification (user authentication) is conducted in advance in the information processing apparatus 121 to which the client application software is allocated.

In the following description, the client application software verifies a specification of the information presentation apparatus 123, converts the virtual reality space information transmitted from the image generating apparatus 110 into virtual reality space information according to the verified specification, and displays the converted virtual reality space information.

In the following description, the client application software verifies the information processing apparatus 121 and transmits the sensor data obtained as a result of sensing the non-verbal behavior of the user 140 to the image generating apparatus 110 in association with the information processing apparatus 121.

In the following description, it is assumed that the user 140 has one type of identifier for identifying the user 140. However, in a case where the image generating system 100 provides two or more services, the user 140 may have a different identifier for each of the services. In such a case, however, it is assumed that a correspondence between different types of identifiers owned by the user 140 is managed by the image generating system 100.

In the following description, it is assumed that the head position sensor, the depth sensor, and the EMG sensor sense the non-verbal behavior of the user 140 as the information collection apparatuses 124 to 126; however, other sensors may detect non-verbal behavior of the user 140. Other sensors include, for example, a video image capturing apparatus, a photo image (color image) capturing apparatus, an audio acquiring apparatus, a biometric sensor, and the like.

In a non-contact sensor, for example, there may be no data of the user 140 in the sensor data as in a case where the user 140 is not presented in the photo image that captures the user 140. Further, for example, there may be a case where two or more users are captured in a photo image that captures the user 140, so that it is not identifiable which user has been sensed.

In this embodiment, it is assumed that a countermeasure for such a case is taken separately, and it is assumed that the sensor data are correctly associated with the user 140 in the image generating apparatus 110.

In the following description, it is assumed that the sensor data sensed by the information collection apparatuses 124 to 126 themselves are transmitted to the image generating apparatus 110; however, intermediate information derived from the sensed sensor data may be transmitted to the image generating apparatus 110. For example, in a case of sensing facial image data of the user 140, information representing the magnitude of change in a smile derived by focusing on face parts of the user 140 may be transmitted to the image generating apparatus 110. Alternatively, information representing a posture change derived by focusing on the size of the face of the user 140 may be transmitted to the image generating apparatus 110.

Further, in the following description, it is assumed that a time stamp is added to the sensor data transmitted from the information processing apparatuses 121 and 131. In addition, it is assumed that time is aligned between the client-side system 120 and the client-side system 130 at the time at which a time stamp is added.

### Virtual Reality Space Image

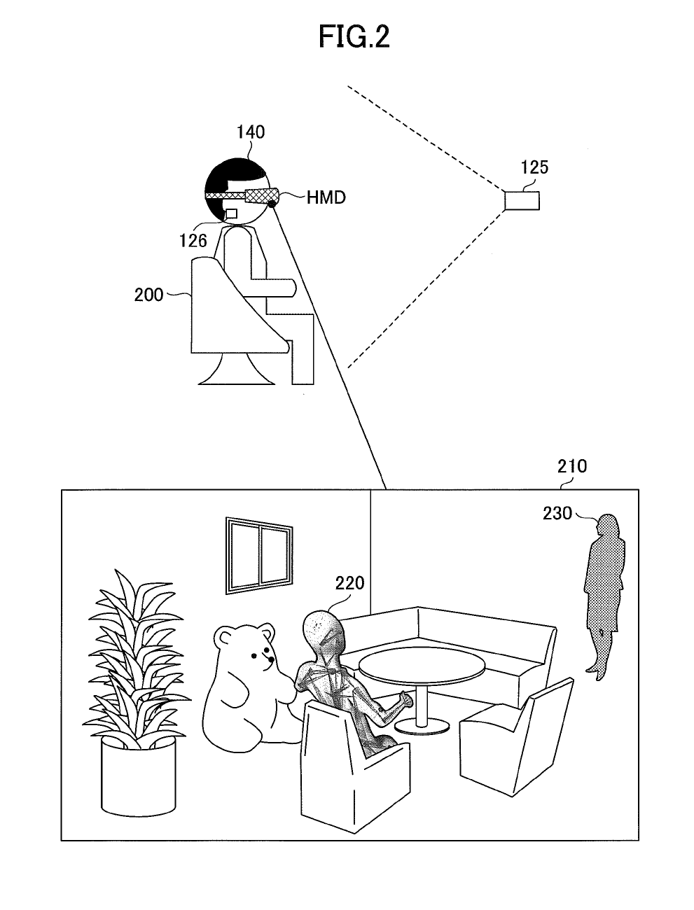

Next, a description is given of a virtual reality space image including an avatar image of the user 140. FIG. 2 is a diagram illustrating an example of a virtual reality space image.

As illustrated in FIG. 2, the user 140 who uses a communication service wears a HMD (the HMD with the head position sensor 124 and the display unit 123 implemented thereon) and the EMG sensor 126 in real space and sits on a chair 200, for example. Further, a depth sensor 125 is installed in front of the user 140 to sense the user 140.

Head posture data, depth sensor data, and EMG data obtained by sensing of the head position sensor 124, the depth sensor 125, and the EMG sensor 126 are transmitted to the image generating apparatus 110, such that the image generating apparatus 110 generates an avatar image of the user 140. A similar process is performed for the user 150, such that the image generating apparatus 110 generates an avatar image of the user 150.

Further, the avatar image generated in the image generating apparatus 110 is incorporated in a virtual reality space image, and the virtual reality space image incorporating the generated avatar image is transmitted to each of the information processing apparatuses 121 and 131 as virtual reality space information.

The image 210 illustrated in FIG. 2 is an example of the virtual reality space image included in virtual reality space information transmitted to the information processing apparatus 121, and the image 210 incorporates an avatar image 220 of the user 140 and an avatar image 230 of the user 150. As illustrated in FIG. 2, the image 210 is displayed such that the user 140 sees the avatar image 220 of the user 140 herself from behind the avatar image 220. When the user 140 performs non-verbal behavior in this state, the avatar image 220 in the image 210 also changes. According to the image 210, the user 140 may identify the avatar image 220, which changes within virtual reality space due to the non-verbal behavior of the user 140 herself, from behind the avatar image 220.

### Method of Representing Avatar Image

Next, a description is given of a method of representing the avatar image in virtual reality space. The avatar image in virtual reality space may be represented using different representing styles for different parts of the body in order to reflect the nonverbal behavior of a user in real space. However, in the following description, it is assumed that any part is represented by using an avatar skeleton model.

As described above, multiple avatar body bones are arranged within the avatar skeleton model. For example, a head of the avatar skeleton model has an avatar body bone of the head. The position and the rotation angle of the avatar body bone of the head are calculated based on head posture data. Avatar body bones of limbs other than the head are arranged in the limbs other than the head of the avatar skeleton model. The position and rotation angle of these avatar body bones are calculated based on the depth data.

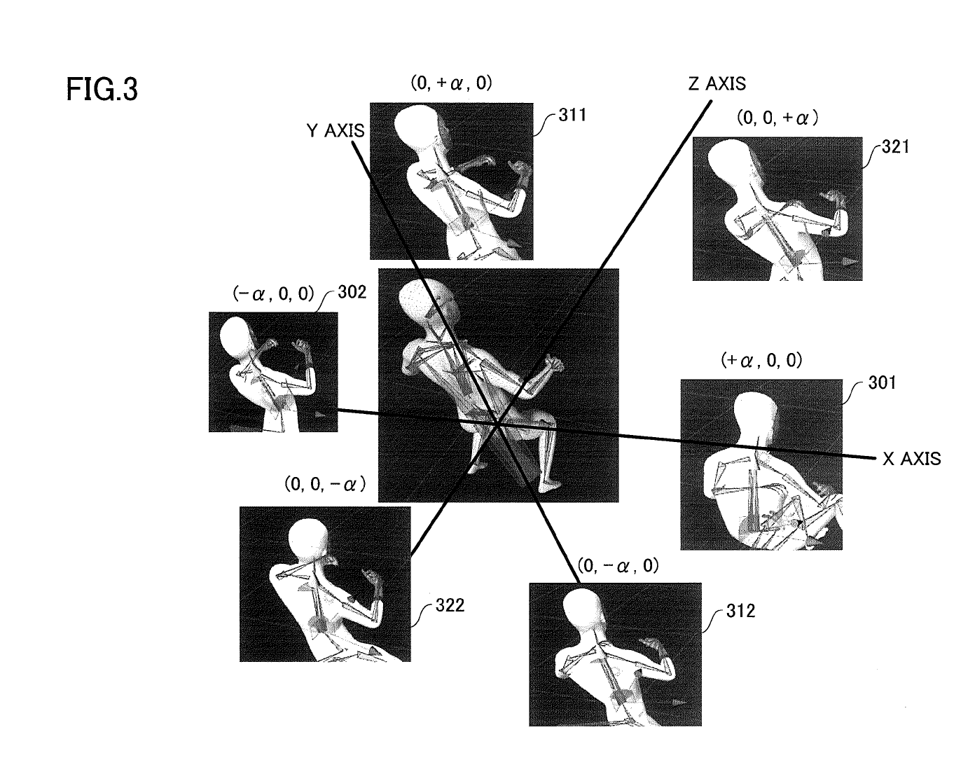

In the following, a description is given of a method of representing an image of an upper part of the body of an avatar using an avatar skeleton model. FIG. 3 is a diagram illustrating an example of a method of representing movements of a user as an avatar image, such as movement of the upper part of the body of the user that leans forward or leans backward, movement of changing orientation of the upper part of the body so as to allow the user to look around the left and right, and movement of the entire upper part of the body of the user that sways from side to side. In representing an image of an upper part of the body of an avatar using the avatar skeleton model, these movements may be represented as a change in a rotation angle of an avatar body bone (“Bone_Chest”) with respect to three axial directions with a position of the waist of the avatar as an origin.

In FIG. 3, an X axis, a Y axis, and a Z axis of the coordinates system uniquely determined in virtual reality space are set as a left-right direction, an up-down direction, and a front-rear direction of the avatar, respectively.

An image 301 depicts an avatar image of the avatar body bone (“Bone_Chest”) that rotates +α [degrees] with respect to the X axis, and an image 302 depicts an avatar image of the avatar body bone that rotates −α [degrees] with respect to the X axis. An image 311 depicts an avatar image of the avatar body bone that rotates +α [degrees] with respect to the Y axis, and an image 312 depicts an avatar image of the avatar body bone that rotates −α [degrees] with respect to the Y axis.

An image 321 depicts an avatar image of the avatar body bone that rotates +α [degrees] with respect to the Z axis, and an image 322 depicts an avatar image of the avatar body bone that rotates −α [degrees] with respect to the Z axis.

### Hardware Configuration of Image Generating Apparatus

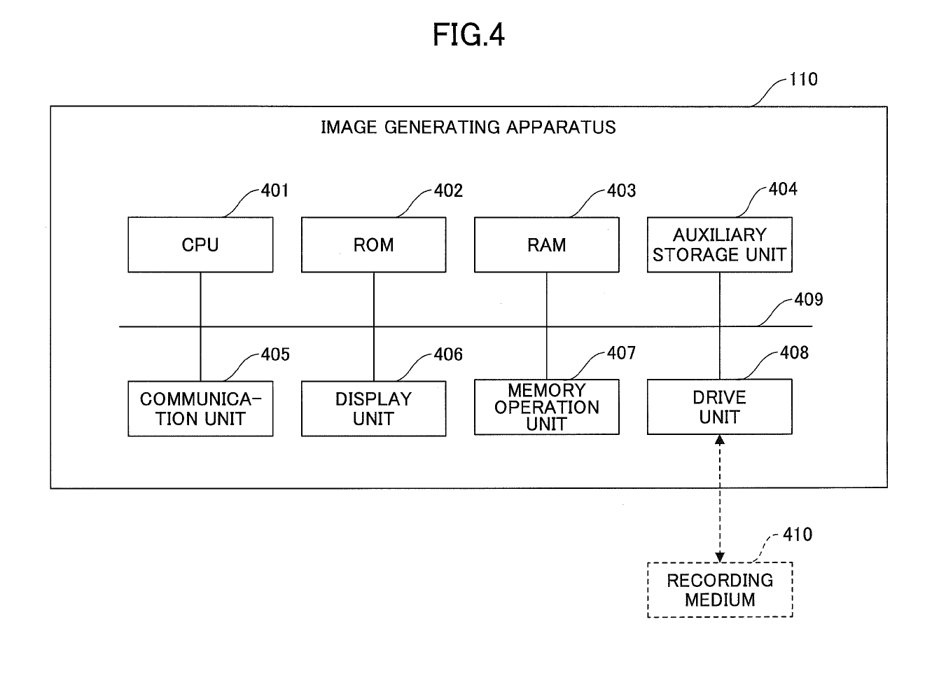

Next, a description is given of a hardware configuration of the image generating apparatus 110 included in the image generating system 100. FIG. 4 is a diagram illustrating an example of a hardware configuration of the image generating apparatus 110. As illustrated in FIG. 4, the image generating apparatus 110 includes a CPU (Central Processing Unit) 401, a ROM (Read Only Memory) 402, and a RAM (Random Access Memory) 403. Further, the image generating apparatus 110 includes an auxiliary storage unit 404, a communication unit 405, a display unit 406, a memory operation unit 407, and a drive unit 408. Note that the respective units of the image generating apparatus 110 are mutually connected via a bus 409.

The CPU 401 is configured to execute various programs (e.g., server software) installed in the auxiliary storage unit 404. The ROM 402 is a nonvolatile memory. The ROM 402 is a main storage unit configured to store various programs, data, and the like necessary for the CPU 401 to execute the various programs stored in the auxiliary storage unit 404. Specifically, the ROM 402 stores boot programs such as BIOS (Basic Input/Output System) and EFI (Extensible Firmware Interface).

The RAM 403 is a volatile memory such as DRAM (Dynamic Random Access Memory) or SRAM (Static Random Access Memory), and functions as a main storage unit. The RAM 403 is configured to provide a work area to be expanded when various programs stored in the auxiliary storage unit 404 are executed by the CPU 401.

The auxiliary storage unit 404 is configured to store various programs installed in the image generating apparatus 110 and information (various contents, various definition information, etc.) used for executing various programs. In addition, the auxiliary storage unit 404 stores information (sensor data, log DB table, etc.) acquired by executing various programs.

The communication unit 405 is used for communicating with the information processing apparatuses 121 and 131 of the client-side systems 120 and 130 connected to the image generating apparatus 110. The display unit 406 is used for displaying a process result and a process state of the image generating apparatus 110. The memory operation unit 407 is used for inputting various instructions to the image generating apparatus 110.

The drive unit 408 is used for setting a recording medium 410. The recording medium 410 referred to in this example includes a medium configured to optically, electrically or magnetically record information, such as a CD-ROM, a flexible disk, a magneto-optical disk and the like. The recording medium 410 also includes a semiconductor memory or the like for electrically recording information such as a ROM, a flash memory, or the like.

Note that various programs to be installed in the auxiliary storage unit 404 are installed, for example, when the distributed recording medium 410 is set in the drive unit 408 and various programs recorded on the recording medium 410 are read by the drive unit 408. Alternatively, various programs to be installed in the auxiliary storage unit 404 may be installed by receiving them from the network 160 via the communication unit 405

### Hardware Configuration of HMD Equipped With Information Processing Apparatus

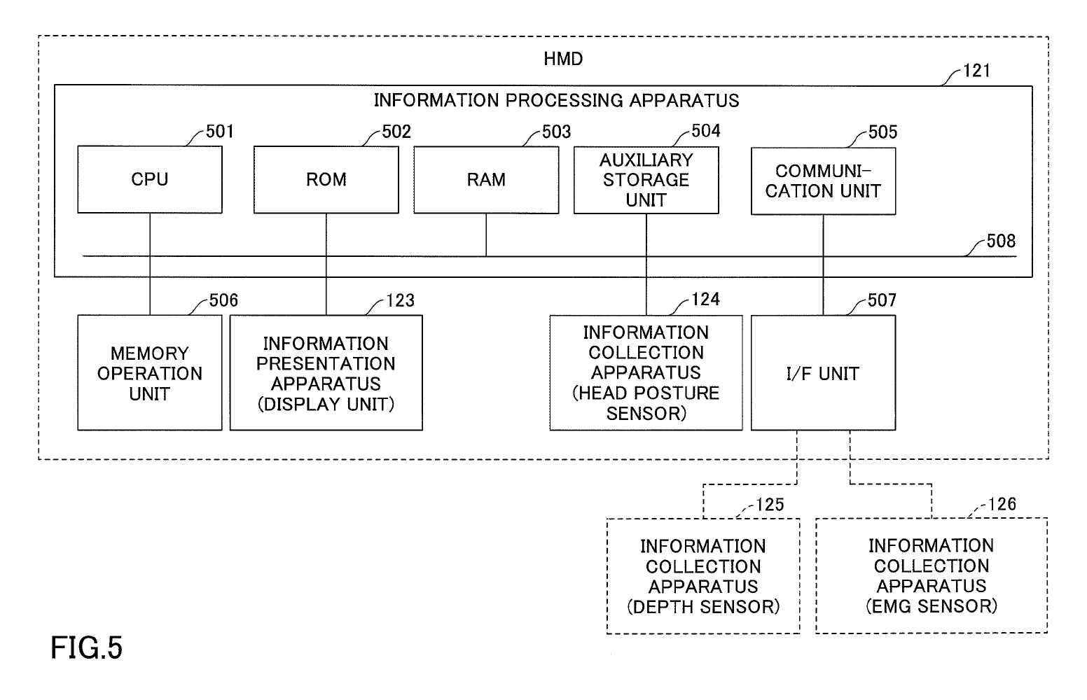

Next, a description is given of a hardware configuration of an HMD on which the information processing apparatus 121 is implemented. FIG. 5 is a diagram illustrating an example of a hardware configuration of the HMD on which the information processing apparatus is implemented. As illustrated in FIG. 5, the information processing apparatus 121 implemented on the HMD includes a CPU 501, a ROM 502, and a RAM 503. The information processing apparatus 121 implemented on the HMD further includes an auxiliary storage unit 504 and a communication unit 505. The HMD includes an operation unit 506, a display unit 123, a head posture sensor 124, and an I/F (interface) unit 507, which are mutually connected via a bus 508. The HMD further includes an audio output device (speaker etc.) and an audio acquisition device (microphone, etc.). Since a description of transmission and reception of audio data is omitted in the first embodiment, a description of devices related to audio (voice) is also omitted.

The CPU 501 is a computer configured to execute various programs (e.g., client application software) installed in the auxiliary storage unit 504. The ROM 502 is a nonvolatile memory. The ROM 502 is a main storage unit configured to store various programs, data, and the like necessary for the CPU 501 to execute the various programs stored in the auxiliary storage unit 504. Specifically, the ROM 502 stores boot programs such as BIOS and EFI.

The RAM 503 is a volatile memory such as DRAM or SRAM, and functions as a main storage unit. The RAM 503 is configured to provide a work area to be expanded when various programs stored in the auxiliary storage unit 504 are executed by the CPU 501.

The auxiliary storage unit 504 is configured to store various programs installed in the image generating apparatus 110 and information used for executing various programs. The communication unit 505 is used for communicating with the image generating apparatus 110.

The operation unit 506 is used for inputting various instructions to the HMD. The display unit 123 is used for displaying a virtual reality space image included in virtual reality space information transmitted from the image generating apparatus 110.

The head posture sensor 124 is configured to sense “head orientation” included in non-verbal behavior in real space of the user 140 and outputs head posture data.

The I/F unit 507 is connected to the depth sensor 125 and the EMG sensor 126, and is configured to acquire the depth sensor data output from the depth sensor 125 and the EMG data output from the EMG sensor 126, respectively.

The obtained sensor data such as the head posture data, the depth sensor data, the EMG data and the like are transmitted to the image generating apparatus 110 via the communication unit 505. The example of FIG. 5 depicts a case where the HMD is formed as an integrated apparatus; however, the HMD may be formed integrally or may be formed of two or more separate devices.

### Functional Configuration of Restricting Unit of Image Generating Apparatus

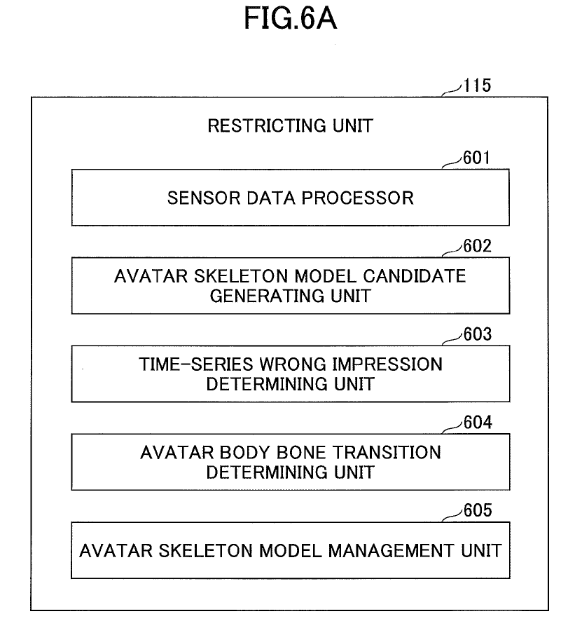

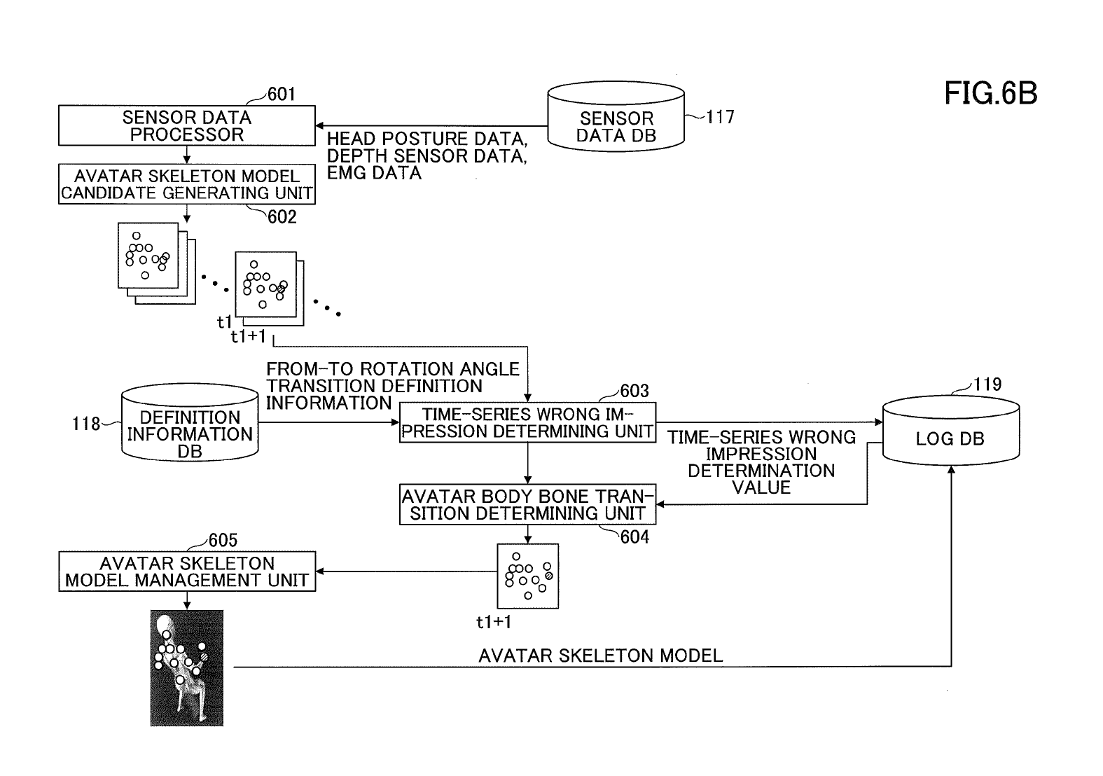

Next, a description is given of a functional configuration of a restricting unit 115 of the image generating apparatus 110. FIGS. 6A and 6B are first diagrams illustrating a functional configuration of a restricting unit of the image generating apparatus 110. As illustrated in FIG. 6A, the restricting unit 115 includes a sensor data processor 601, an avatar skeleton model candidate generating unit 602, a time-series wrong impression determining unit 603, an avatar body bone transition determining unit 604, and an avatar skeleton model management unit 605.

The sensor data processor 601 is an example of a first acquirer and a second acquirer. As illustrated in FIG. 6B, the sensor data processor 601 is configured to read the sensor data transmitted from the client-side systems 120 and 130 and stored in the sensor data DB 117. The sensor data are stored separately for each type (head posture data, depth sensor data, EMG data in the first embodiment) in the sensor data DB 117.

The avatar skeleton model candidate generating unit 602 is an example of a generating unit. The avatar skeleton model candidate generating unit 602 is configured to calculate a position of each part in real space of the user 140 based on the sensor data read from the sensor data DB 117. The avatar skeleton model candidate generating unit 602 also calculates a position and a rotation angle of each avatar body bone in virtual reality space based on the calculated position of each part by using an existing API (Application Programming Interface). Furthermore, the avatar skeleton model candidate generating unit 602 generates the avatar skeleton model candidate by reflecting the position and rotation angle of each avatar body bone in the calculated virtual reality space.

Note that the avatar skeleton model candidate generating unit 602 generates an avatar skeleton model candidate at a time t1+1 based on the sensor data at time t1+1 next to the time t1.

Note that the generation method of the avatar skeleton model candidate is not limited to this example. For example, the avatar skeleton model candidate may be generated after applying a moving average process with respect to the position and the rotation angle of the avatar body bone calculated by using the API. Alternatively, the avatar skeleton model candidate generating unit 602 may generate the avatar skeleton model candidate located in the lower half of the body without using the API.

The time-series wrong impression determining unit 603 is an example of a calculator. The time-series wrong impression determining unit 603 calculates a transition between the time t1 and the time t1+1 for each of avatar body bones of the avatar skeleton model candidate so as to determine whether the transition gives wrong impression. The time-series wrong impression determining unit 603 determines whether the transition gives wrong impression by referring to “from-to rotation angle transition definition information causing wrong impression” (hereinafter referred to as “from-to rotation angle transition definition information”, which will be described in detail later) stored in the definition information DB.

Further, the time-series wrong impression determining unit 603 records a determination result (e.g., a time-series wrong impression determination value) as to whether the transition gives wrong impression in the “time-series wrong impression determination value calculation log DB table” (hereinafter referred to as a “determination value log DB table”, which will be described in detail later).

The avatar body bone transition determining unit 604 is an example of a determining unit. The avatar body bone transition determining unit 604 is configured to determine whether to reflect, in the avatar skeleton model, the position and rotation angle of the avatar body bone calculated on the basis of the sensor data at time t1+1, based on the time-series wrong impression determination value in the time-series wrong impression determining unit 603.

When the avatar body bone transition determining unit 604 determines that none of the avatar body bones give wrong impression, the avatar body bone transition determining unit 604 determines to reflect all the avatar body bones based on the sensor data at time t1+1 in the avatar skeleton model.

When the avatar body bone transition determining unit 604 determines that a part of the avatar body bones gives wrong impression, the avatar body bone transition determining unit 604 determines not to reflect the part of the avatar body bones based on the sensor data at time t1+1 in the avatar skeleton model. In this case, the avatar body bone transition determining unit 64 determines the transition of a part of the avatar body bone between time t1 and time t1+1 within a range not to give wrong impression.

The avatar skeleton model management unit 605 is an example of an output unit. The avatar skeleton model management unit 605 gives an instruction to the information display processor 112 based on the determination result by the avatar body bone transition determining unit 604.

When the avatar body bone transition determining unit 604 determines to “reflect” all the avatar body bones, the avatar skeleton model management unit 605 gives an instruction to display the avatar image at time t1+1 generated by the information display processor 112.

As a result, at the time t1+1, the information display processor 112 outputs the avatar image at time t1+1 generated by the information display processor 112 instead of the avatar image at time t1.

By contrast, when the avatar body bone transition determining unit 604 determines “not to reflect” the part of the avatar body bones, the avatar skeleton model management unit 605 generates an avatar skeleton model at time t1+1. In addition, the avatar skeleton model management unit 605 transmits to the information display processor 112 the image (avatar image) of the avatar skeleton model at time t1+1 and gives an instruction to display the transmitted image.

Note that the avatar skeleton model management unit 605 generates an avatar skeleton model at time t1+1 and gives an instruction to display the avatar image at time t1+1 in the following procedure.

With respect to the avatar body bone that the avatar body bone transition determining unit 604 determines to “reflect”, among multiple avatar body bones included in the avatar body bone, the position and rotation angle of the avatar body bone calculated based on the sensor data at time t1+1 is reflected in the avatar skeleton model.
With respect to the avatar body bone that the avatar body bone transition determining unit 604 determines “not to reflect”, among the multiple avatar body bones included in the avatar body bone, the position and rotation angle of the avatar body bone that change its angle of transition within a range not to give wrong impression are reflected in the avatar skeleton model.

As a result, at the time t1+1, the information display processor 112 outputs the avatar image at time t1+1 generated by the avatar skeleton model management unit 605 instead of the avatar image at time t1.

Furthermore, the avatar skeleton model management unit 605 records the avatar skeleton model generated by the above procedure in the avatar body bone log DB table (which will be described in detail later) of the log DB 119.

In the above description, with respect to the avatar body bone that the avatar body bone transition determining unit 604 determines not to “reflect”, the avatar skeleton model management unit 605 reflects the avatar body bone that transitions within a range not to give wrong impression in the avatar skeleton model. However, with respect to the avatar body bone determined as “not to reflect”, the avatar skeleton model management unit 605 may reflect the avatar body bone reflected at time t1 continuously in the avatar skeleton model at time t1+1.

### Sensor Data Stored in Sensor Data DB

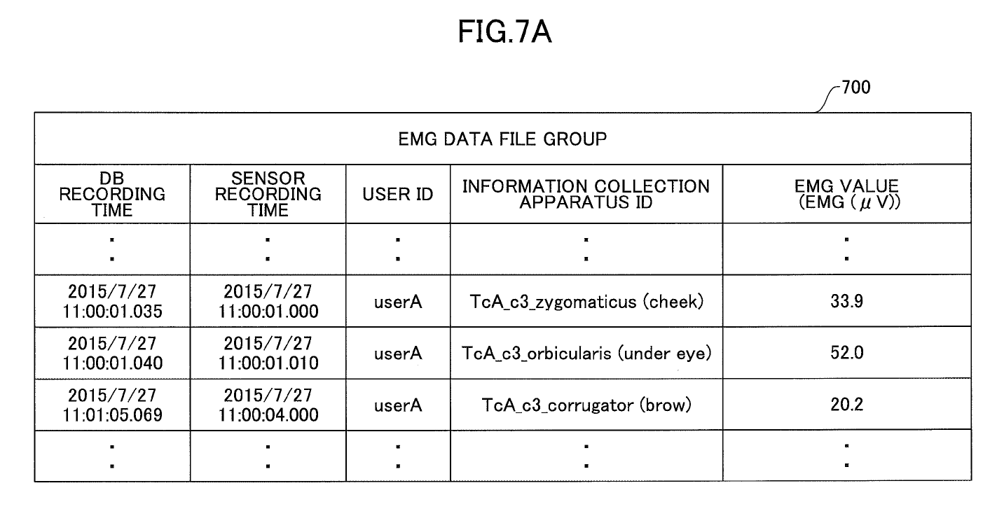

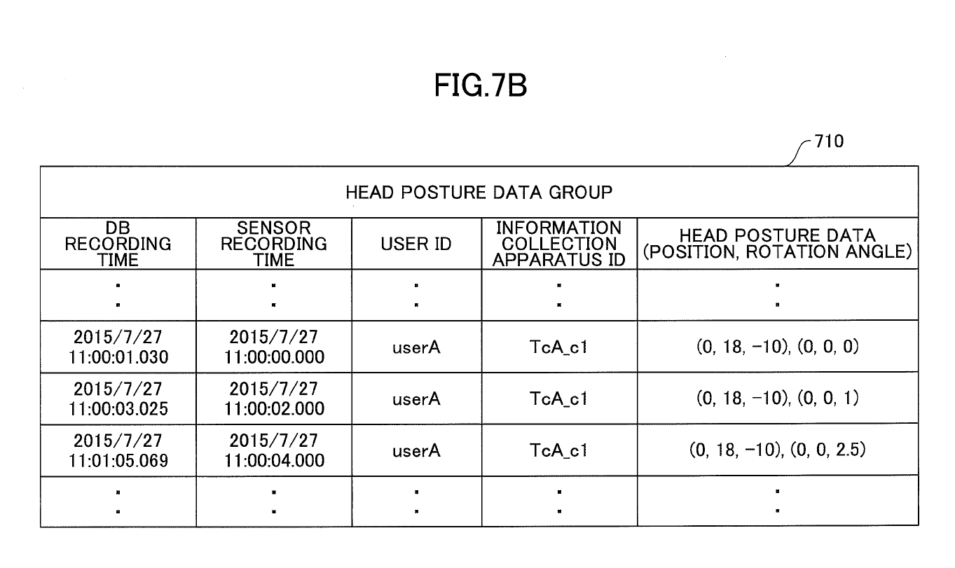

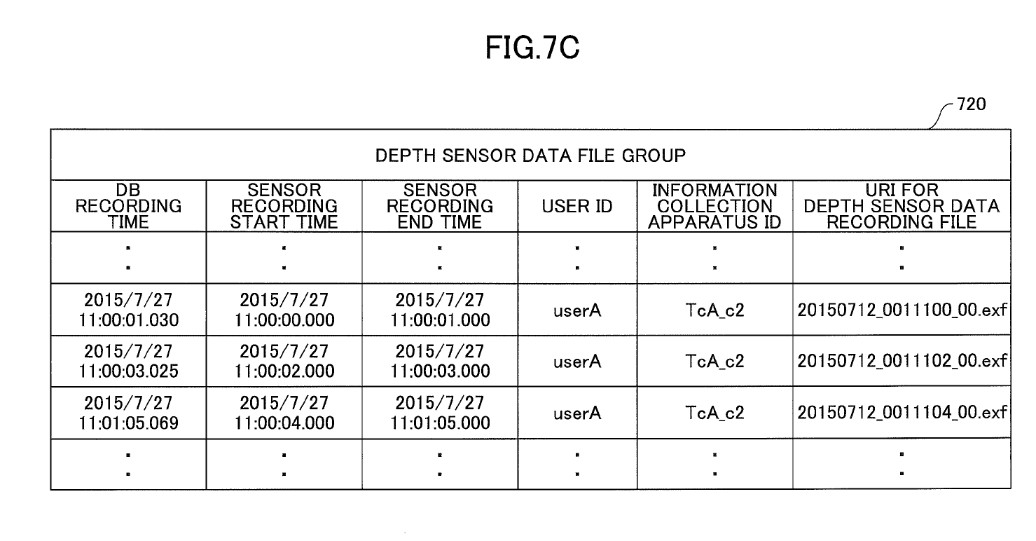

Next, a description is given of sensor data stored in the sensor data DB 117. FIGS. 7A to 7C are diagrams illustrating examples of sensor data stored in the sensor data DB.

Among these, FIG. 7A illustrates a EMG data group 700 having the EMG data. As illustrated in FIG. 7A, the EMG data group 700 having the EMG data includes “DB recording time”, “sensor recording time”, “user ID”, “information collection apparatus ID”, and “myoelectric potential activity value”.

With respect to the “DB recording time”, a time stamp added at the time when the EMG data transmitted from the client-side systems 120 and 130 are stored in the sensor data DB 117 is recorded.

With respect to the “sensor recording time”, the time stamp added at the time when the EMG sensors 126 and 136 have sensed the users 140 and 150 is recorded.

With respect to the “user ID”, identifiers identifying the users 140 and 150 sensed by the EMG sensors 126 and 136 are recorded.

With respect to the “information collection apparatus ID”, an identifier for identifying a sensor is recorded. Myogenic potential sensors have different identifiers depending on the sensing location. “TcA_c3_zygomaticus (cheek)” in the first line of the data row in FIG. 7A is an identifier of a EMG sensor that senses cheeks. “TcA_c3_orbicularis (undereye)” in the second line of the data row in FIG. 7A is an identifier of a EMG sensor that senses lower parts of the eyes. “TcA_c3_corrugator (blow)” in the third row of the data row in FIG. 7A is an identifier of a EMG sensor that senses eyebrows.

With respect to the “myoelectric potential activity value”, a value of the EMG data sensed by each EMG sensor is recorded.

FIG. 7B illustrates a head posture data group 710 having the head posture data. As illustrated in FIG. 7B, information items included in the head posture data group 710 are substantially the same as information items included in the EMG data group 700.

Note that in the “information collection apparatus ID” of the head posture data group 710, “TcA_c1” indicates an information collection apparatus having an information collection apparatus type “c1” that is in association with the information processing apparatus having an information processing apparatus ID “TcA”. Specifically, “TcA_c1” indicates the head posture sensor 124 associated with the information processing apparatus 121.

The “head posture data” record data indicating the position of the head and data indicating the rotation angle of the head.

FIG. 7C illustrates a depth sensor data file group 720 having depth sensor data. As illustrated in FIG. 7C, information items included in the depth sensor data file group 720 include “DB recording time”, “user ID”, “information collection apparatus ID”, “sensor recording start time”, “sensor recording end time”, and “depth sensor data recording file URI”.

With respect to the “sensor recording start time”, the time at which the depth sensors 125 and 135 start sensing is recorded. In a case of the depth sensors 125 and 135, sensor data are output as a file having a predetermined recording data size. With respect to the “sensor recording start time”, time stamp added at the time of sensing the first depth sensor data included in each file is recorded.

With respect to the “sensor recording end time”, the time at which the depth sensors 125 and 135 end their sensing is recorded. Specifically, the time stamp added at the time of sensing the last depth sensor data included in a file having a predetermined recording data size is recorded.

With respect to the “depth sensor data recording file URI”, a URI indicating a storage location of a file having a predetermined recording data size is recorded.

Note that in the “information collection apparatus ID” of the depth sensor data file group 720 , “TcA_c2” indicates an information collection apparatus having an information collection apparatus type “c2” that is in association with the information processing apparatus having the information processing apparatus ID “TcA”. Specifically, “TcA_c2” indicates the depth sensor 125 associated with the information processing apparatus 121.

### From-to Rotation Angle Transition Definition Information Stored in Definition Information DB

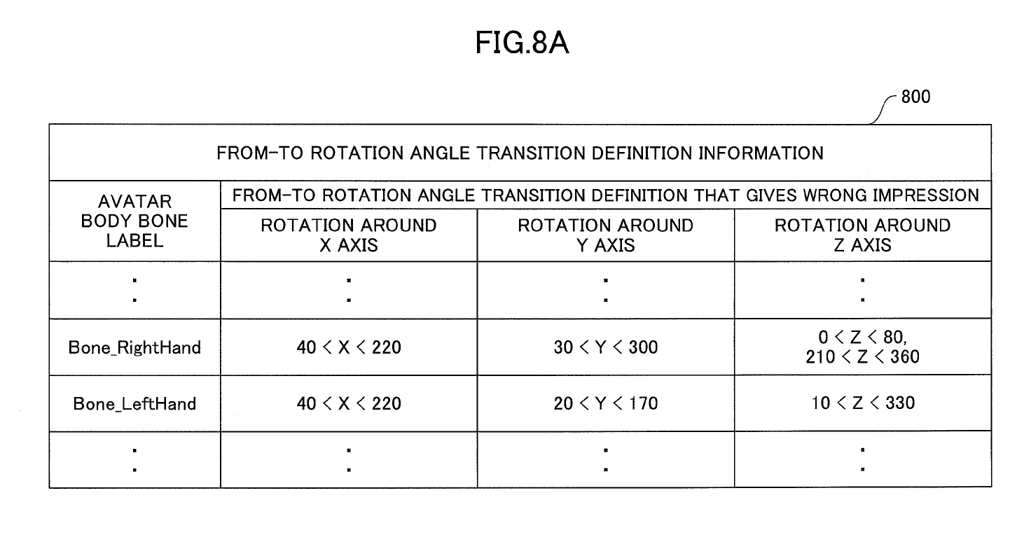

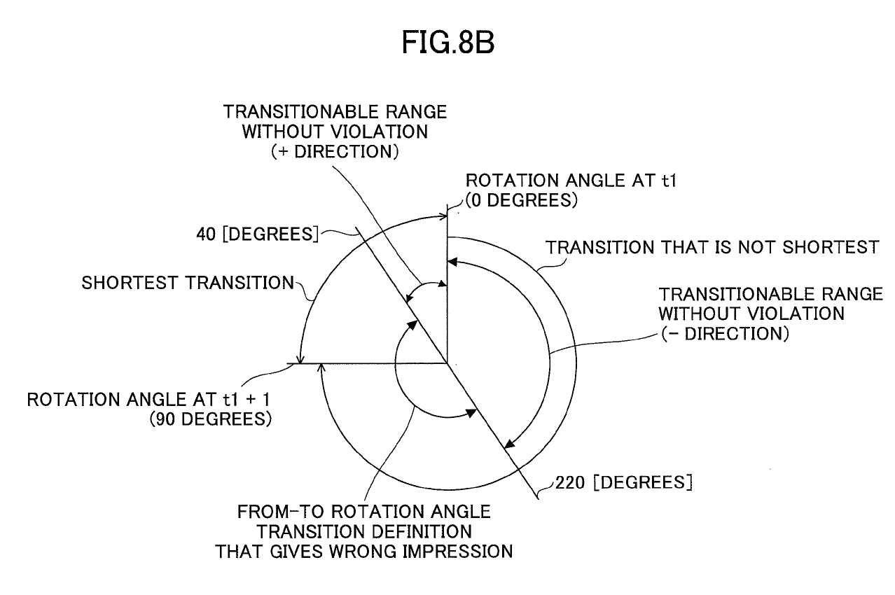

Next, a description is given of “from-to rotation angle transition definition information” stored in the definition information DB 118. FIGS. 8A and 8B are diagrams illustrating an example of from-to rotation angle transition definition information stored in a definition information DB.

As illustrated in FIG. 8A, from-to rotation angle transition definition information 800 includes an “avatar body bone label” and “wrong impression giving from-to rotation angle transition definition” as information items.

With respect to the “avatar body bone label”, information identifying one of the multiple avatar body bones included in the avatar skeleton model candidate is stored.

The “wrong impression giving from-to rotation angle transition definition” stores information indicating from-to rotation angle transition to be determined as to whether an wrong impression appears in a rotation of each avatar body bone with respect to each axis.

The “wrong impression giving from-to rotation angle transition definition” is defined for each of the X axis, the Y axis, and the Z axis in virtual reality space. In a case of the avatar body bone label=“Bone_RightHand” (a right hand bone of the avatar) in the example of the first line in the data row illustrated in FIG. 8A, transition within a rotation angle range with respect to the X axis being greater than 40 [degrees] and less than 220 [degrees] gives wrong impression.

FIG. 8B illustrates a relationship between a from-to rotation angle transition definition that gives wrong impression and avatar body bone rotation angle transition in a case where the avatar body bone label=“Bone_RightHand”. FIG. 8B illustrates a case where the rotation angle of the avatar body bone being 0 [degrees] at time t1 has rotated to 90 [degrees] with respect to the X axis at time t1+1.

In this case, the transition in a forward direction, among the transitions of the rotation angle of the avatar body bone between the time t1 (0 [degrees]) and the time t1+1 (90 [degrees]), represents “shortest transition”. By contrast, the transition in a backward direction represents “non-shortest transition”.

Further, according to the from-to rotation angle transition definition information 800, the from-to rotation angle transition definition that gives wrong impression is defined as “40<X<220”. Hence, the range in the forward direction from 0 [degrees] to 40 [degrees] indicates “a range (in a + direction) capable of transition without violating” the from-to rotation angle transition definition. Further, the range in the backward direction from 0 [degrees] to 220 [degrees] indicates “a range (in a − direction) capable of transition without violating” the from-to rotation angle transition definition.

It is assumed that the above-described definitions in the from-to rotation angle transition definition information 800 may be statically generated collectively, for example, by the administrator of the image generating apparatus 110. Alternatively, the above-described definitions in the from-to rotation angle transition definition information 800 may be generated based on previous history data such as a time zone, place, situation, characteristics of a user or a user group, contents of communication, etc., in addition to the above-described definitions in order to include consideration indicating that the above-described definitions differ depending on the situations. Alternatively, the above-described definitions may be dynamically generated from temporally recent history data or the like.

### Avatar Skeleton Model Updating Process

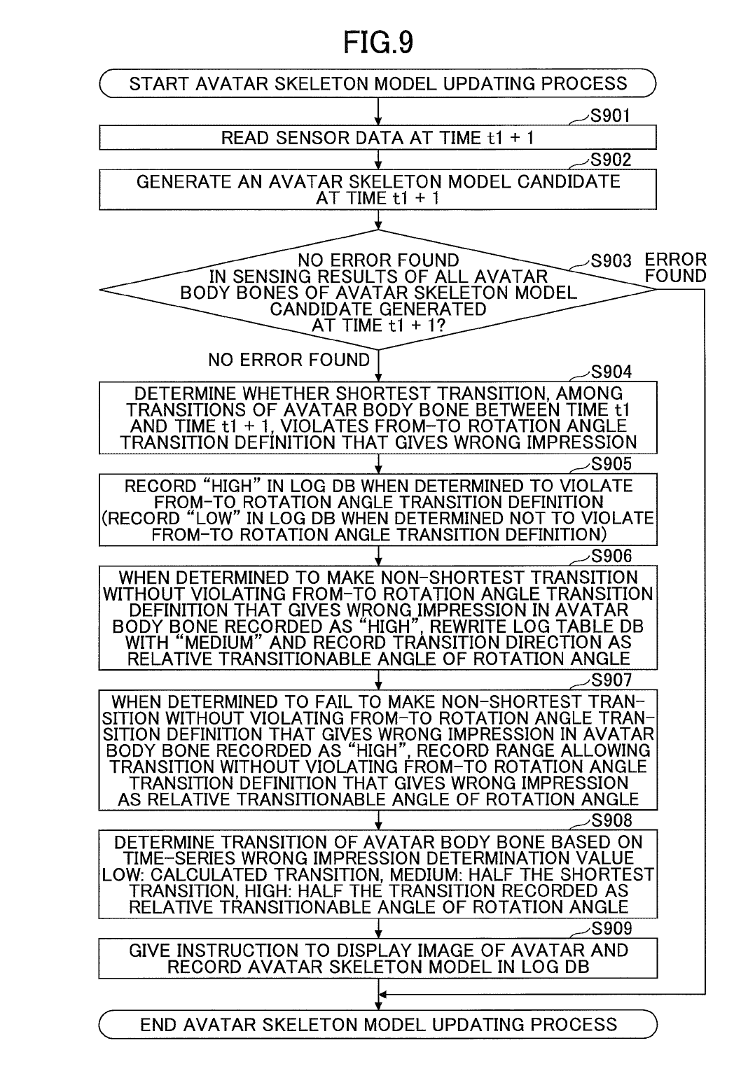

Next, a description is given of a flow illustrating an avatar skeleton model updating process performed by the restricting unit 115. FIG. 9 is a first flowchart of an avatar skeleton model updating process. The flowchart illustrated in FIG. 9 is periodically executed by the restricting unit 115 at predetermined time intervals. Alternatively, the flowchart may be executed by the restricting unit 115 at a timing at which a predetermined amount or more of sensor data are stored in the sensor data DB 117.

In step S901, the sensor data processor 601 reads sensor data at time t1+1 from the sensor data DB 117.

In step S902, the avatar skeleton model candidate generating unit 602 generates an avatar skeleton model candidate at time t1+1 based on the read sensor data.

In step S903, the avatar skeleton model candidate generating unit 602 determines whether there is any error in a sensing result of any of the avatar body bones of the avatar skeleton model candidate at time t1+1.

In step S903, when it is determined that there is an error in the sensing result in any avatar body bone of the avatar skeleton model candidate at time t1+1, the avatar skeleton model updating process will end after a determination result is transmitted to the information display processor 112.

In this case, the information display processor 112 generates an avatar image and displays the generated avatar image so as to clarify that the sensing result includes an error, for example.

By contrast, when it is determined in step S903 that there is no error in the sensing result of any of the avatar body bones of the avatar skeleton model candidate at time t1+1, the process proceeds to step S904.

In step S904, the time-series wrong impression determining unit 603 determines whether the shortest transition, among the transitions between time t1 and time t1+1, violates the from-to rotation angle transition definition that gives wrong impression, for each avatar body bone.

Specifically, the time-series wrong impression determining unit 603 refers to the from-to rotation angle transition definition information 800. The time-series wrong impression determining unit 603 determines whether the shortest transition between time t1 and time t1+1 violates the from-to rotation angle transition definition that gives wrong impression, for each avatar body bone. Note that the time-series wrong impression determining unit 603 makes a determination on each of the X axis, the Y axis, and the Z axis.

In step S905, the time-series wrong impression determining unit 603 records a time-series wrong impression determination value=“high” in the determination value log DB table (details will be described later) of the log DB 119 for the axis that violates the from-to rotation angle transition definition that gives wrong impression. Further, the time-series wrong impression determining unit 603 records a time-series wrong impression determination value=“low” in the determination value log DB table of the log DB 119 for the axis that does not violate the from-to rotation angle transition definition that gives wrong impression.

In step S904, the time-series wrong impression determining unit 603 determines whether to make a transition that is not the shortest (hereinafter referred to as a “non-shortest transition”) between time t1 and time t1+1 with respect to the avatar body bone recorded as “high” without violating the from-to rotation angle transition definition that gives wrong impression.

When the time-series wrong impression determining unit 603 determines to make such non-shortest transition without violating the from-to rotation angle transition definition that gives wrong impression, the time-series wrong impression determining unit 603 rewrites the time-series wrong impression determination value recorded in step S905. Specifically, the time-series wrong impression determining unit 603 rewrites the time-series wrong impression determination value from “high” to “medium”. Further, the time-series wrong impression determining unit 603 records a transition direction (+ direction or − direction) enabling transition without violating the from-to rotation angle transition definition that gives wrong impression, as “relative transitionable angle of a rotation angle”, in the determination value log DB table of the log DB 119. Note that when rotation is made with respect to the X axis, “+” recorded in the relative variation indicates a forward direction and “−” recorded in the relative variation indicates that a backward direction. Further, when rotation is made with respect to the Y axis, “+” recorded in the relative variation indicates a rightward direction and “−” recorded in the relative variation indicates that a leftward direction. In addition, when rotation is made with respect to the Z axis, “+” recorded in the relative variation indicates a leftward direction and “−” recorded in the relative variation indicates that a rightward direction.

When the time-series wrong impression determining unit 603 determines that it is not possible to make non-shortest transition without violating the from-to rotation angle transition definition that gives wrong impression, the time-series wrong impression determining unit 603 performs a process of step S907 for the avatar body bone.

In step S907, the time-series wrong impression determining unit 603 records, for the avatar body bone whose log DB table DB has not been rewritten in step S906, a range allowing transition without violating the from-to rotation angle transition definition that gives wrong impression in the determination value log DB table of the log DB 119.

The following illustrates a process of step S907 with reference to a bone of an avatar's left hand as an example. In a case of the bone of the avatar's left hand in rotation with respect to the X axis, among a + direction (forward) transitions from a rotation angle 0 [degrees] to 90 [degrees], a transition from 0 [degrees] to 40 [degrees] will not violate the from-to rotation angle transition definition (i.e., the rotation with respect to the X axis) that gives wrong impression. Thus, the range from 0 [degrees] to 40 [degrees] is recorded in the determination value log DB table as a range that allows transition without violating the from-to rotation angle transition definition that gives wrong impression. In addition, among transitions from 0 [degrees] (360 [degrees]) to 90 [degrees] in a − direction (backward), the transition from 0 [degrees] (360 [degrees]) to 220 [degrees] will not violate the from-to rotation angle transition definition (rotation with respect to the X axis) that gives wrong impression.

Thus, the range from 0 [degrees] to 220 [degrees] is recorded in the determination value log DB table as a range that allows transition without violating the from-to rotation angle transition definition that gives wrong impression.

Note that whether to record any of the ranges that allow transition without violation in the “relative transitionable angle of a rotation angle” is optional. For example, the transition range having the same transition direction as the transition direction of the shortest transition may be selected as the relative transitionable angle of a rotation angle. Alternatively, the transition range that approaches closest to the rotation angle of the avatar body bone at time t1+1 may be selected as the relative transitionable angle of a rotation angle. Further, among the ranges that allow transition without violation, the wider range may be selected as a relative transitionable angle of a rotation angle.

The illustration of the process continues as follows by referring back to FIG. 9. In step S908, the avatar body bone transition determining unit 604 determines transition of each avatar body bone between time t1 and time t1+1 based on the time-series wrong impression determination value determined by the time-series wrong impression determining unit 603.

With respect the avatar body bone of which the time-series wrong impression determination value is determined to be “low”, the avatar body bone transition determining unit 604 determines the transition of the avatar body bone calculated when the avatar skeleton model candidate is generated in step S902 to be the transition of the avatar body bone between time t1 and time t1+1.

With respect to the avatar body bone of which the time-series wrong impression determination value being “medium” or “high” is determined by the time-series wrong impression determining unit 603, the avatar body bone transition determining unit 604 determines the transition of the avatar body bone to be the transition of the avatar body bone differing from that of the avatar body bone having the time-series wrong impression determination value determined to be “low”.

Specifically, the avatar body bone transition determining unit 604 determines the transition of the avatar body bone such that the avatar body bone having the time-series wrong impression determination value determined as “medium” or “high” to transition within a range that does not give wrong impression between time t1 and time t1+1.

For example, the avatar body bone transition determining unit 604 determines the transition of the avatar body bone of which the time-series wrong impression determination value determined as “medium” by the time-series wrong impression determining unit 603 is determined to be half of the transition that is not the shortest.

Further, the avatar body bone transition determining unit 604 determines transition of the avatar body bone of which the time-series wrong impression determination value being “high” is determined by the time-series wrong impression determining unit 603 to be half of the “relative transitionable angle of a rotation angle” recorded in the determination value log DB table.

Since the avatar body bone transition determining unit 604 determines the transition of each avatar body bone according to the time-series wrong impression determination value to make transition of each avatar body bone within a range that gives no wrong impression, an unexpected transition of the avatar body bone may be avoided. In addition, when the user 140 continues to perform similar movements, the movement similar to the movement of the user 140 may be reflected in the avatar skeleton model.

In step S909, the avatar skeleton model management nit 605 gives an instruction to the information display processor 112 based on the determination result in step S908.

Specifically, when the time-series wrong impression determination values of all the avatar body bones included in the avatar skeleton model candidate are “low”, the avatar skeleton model management unit 605 gives an instruction to the information display processor 112 so as to display the image of an avatar at time t1+1 generated by the information display processor 112.

When the time-series wrong impression determination values of part of avatar body bones are “high” or “medium”, the avatar skeleton model management unit 605 gives an instruction to generate an avatar skeleton model by reflecting the transition of the avatar body bone determined in step S908 and to display the generated avatar skeleton model.

Furthermore, the avatar skeleton model management unit 605 records the generated avatar skeleton model in the avatar body bone log DB table (which will be described in detail later) of the log DB 119.

### Information Recorded in Log DB

Next, a description is given of information (a determination value log DB table, and an avatar body bone log DB table) that is recorded in the log DB 119 by executing an avatar skeleton model updating process.

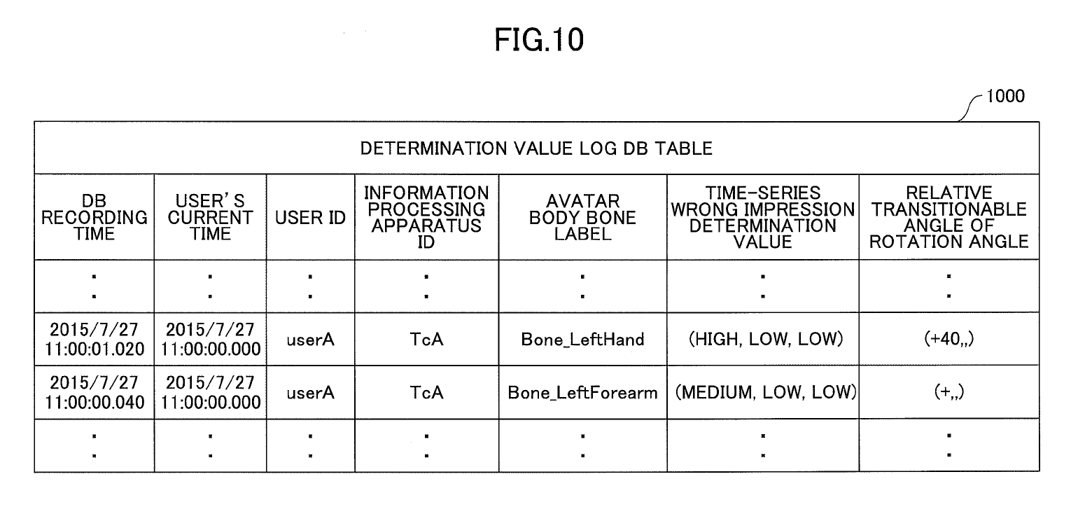

FIG. 10 is a diagram illustrating an example of the determination value log DB table. As illustrated in FIG. 10, the determination value log DB table 1000 includes, as information items, “DB recording time”, “user's current time”, “user ID”, “information processing apparatus ID”, “avatar body bone label”, “time-series wrong impression determination value”, and “relative transitionable angle of a rotation angle”.

The “DB recording time” includes a time stamp that is added when the time-series wrong impression determination value determined by the time-series wrong impression determining unit 603 is recorded in the determination value log DB table 1000 of the log DB 119.

The “user's current time” includes the time stamp (the time at which the user performed non-verbal behavior) added to the sensor data used when the avatar skeleton model candidate generating unit 602 has generated the avatar skeleton model candidate.

The “user ID” includes an identifier for identifying a user. The “information processing apparatus ID” includes an ID of an information processing apparatus.

The “avatar body bone label” includes a label indicating the avatar body bone of which the time-series wrong impression determination value is determined by the time-series wrong impression determining unit 603. The “Bone_LeftHand” is a label indicating the bone of the avatar's left hand. The “Bone_LeftForearm” is a label indicating the bone of the avatar's left forearm.

The “time-series wrong impression determination value includes the time-series wrong impression determination value determined by the time-series wrong impression determining unit 603. The example of the first line of the data row in FIG. 10 indicates that the time-series wrong impression determination value on the X axis is “high” and the time-series wrong impression determination values for the Y axis and the Z axis “low” in the bone of the avatar's left hand. The example of the second line of the data row in FIG. 10 indicates that the time-series wrong impression determination value on the X axis is “medium” and the time-series wrong impression determination values for the Y axis and the Z axis are “low” in the bone of the avatar's left forearm.

The “relative transitionable angle of a rotation angle” includes a range that allows transition without violating the from-to rotation angle transition definition that gives wrong impression with respect to the axis recorded as “high” in the “time-series wrong impression determination value”.

The example of the first line of the data row in FIG. 10 indicates a relative transitionable angle of a rotation angle, which is calculated in a case where at time t1 the rotation angle of the bone of the avatar's left hand with respect to the X axis is 0 [degrees], but at time t1+1 the rotation angle with respect to the X axis has become 90 [degrees]. As described above, in a case of the bone of the avatar's left hand, “40<X<220” is defined as “a from-to rotation angle transition definition (rotation with respect to the X axis) that gives wrong impression”. In addition, among transitions from 0 [degrees] to 90 [degrees] in a + direction (forward), the transition from 0 [degrees] to 40 [degrees] will not violate the from-to rotation angle transition definition (rotation with respect to the X axis) that gives wrong impression. In addition, among transitions from 0 [degrees] (360 [degrees]) to 90 [degrees] in a − direction (backward), the transition from 0 [degrees] (360 [degrees]) to 220 [degrees] will not violate the from-to rotation angle transition definition (rotation with respect to the X axis) that gives wrong impression.

Among them, the example of the first line of the data rows in FIG. 10 indicates a record of the transition from 0 [degrees] to 40 [degrees] is set as a transitionable range without violating the from-to rotation angle transition definition that gives wrong impression. Thus, “+40” which is the rotation angle of the avatar's left hand bone with respect to the X axis between time t1 and time t1+1 is recorded as the “relative transitionable angle of a rotation angle”.

In the case of the avatar's left hand bone, since the time-series wrong impression determination value is “low” with respect to the Y axis and the Z axis, nothing is recorded on the Y axis and the Z axis of the “relative transitional variation”.

In a case of the avatar's left forearm bone, since the time-series wrong impression determination value with respect to the X axis has been rewritten to “medium”, a transition direction without violating the from-to rotation angle transition definition that gives wrong impression is recorded for the X axis of the “relative transitionable angle of a rotation angle”. Specifically, “+” (forward) is recorded. In a case of the avatar's left forearm bone, since the time-series wrong impression determination value is “low” with respect to the Y axis and the Z axis, nothing is recorded on the Y axis and the Z axis of the “relative transitional variation”.

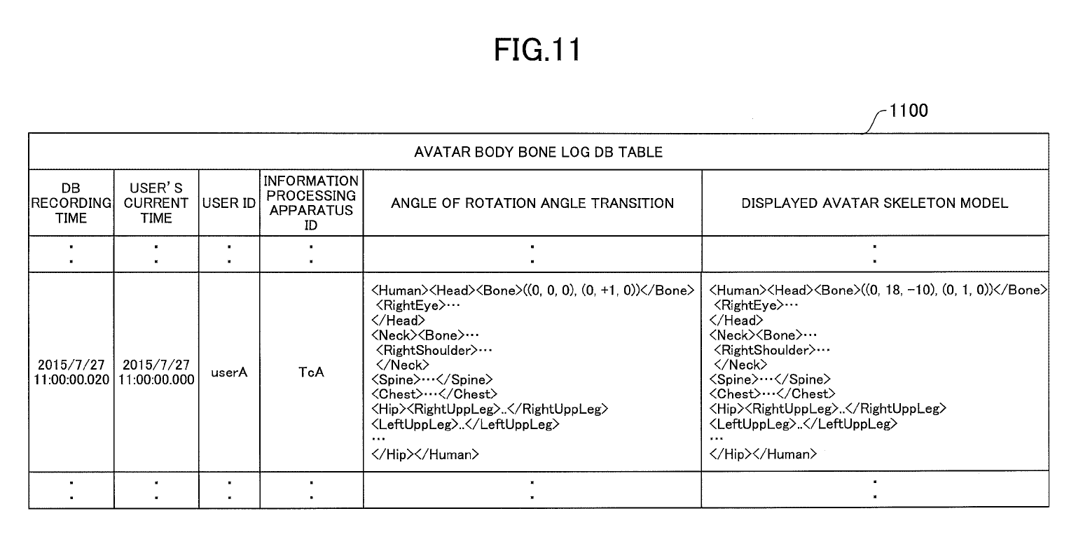

FIG. 11 is a diagram illustrating an example of the avatar body bone log DB table. As illustrated in FIG. 11, the avatar body bone log DB table 1100 includes, as information items, “DB recording time”, “user's current time”, “user ID”, “angle of rotation angle transition”, and “displayed avatar skeleton model”.

The “DB recording time” includes a time stamp added at the time at which the avatar skeleton model management unit 605 has recorded the avatar skeleton model used for displaying the avatar image at time t1+1 in the avatar body bone log DB table 1100.

The “user's current time” includes the time stamp (the time at which the user performed non-verbal behavior) added to the sensor data used when the avatar skeleton model candidate generating unit 602 has generated the avatar skeleton model candidate.

The “user ID” includes an identifier for identifying a user. The “information processing apparatus ID” includes an ID of an information processing apparatus.

The “angle of rotation angle transition” includes a angle of rotation angle transition between time t1 and time t1+1 for each of the avatar body bones of the avatar skeleton model candidate.

The “displayed avatar skeleton model” includes the avatar skeleton model used for displaying the avatar image.

In the first embodiment, when an avatar image is displayed using an avatar skeleton model including an avatar body bone of a transition differing from the sensor data, the movement of the user 140 in real space will not match the transition of the avatar body bone in virtual reality space. Hence, the avatar image (avatar_Local) having the sensor data reflected may be displayed for the user 140. In this case, the avatar image (avatar_Local) to be displayed to the user 140 may be displayed in representation differing from the avatar image 220 (avatar_Network) to be displayed to the user 150.

For example, the avatar_Local may have representation indicating to the user 140 that the sensor data is reflected. Specifically, the avatar_Local may be displayed in a mode where an avatar image such as shadow including a cluster of points may be displayed instead of the avatar image based on the avatar skeleton model. Further, instead of the whole avatar, the body of the avatar may be partially displayed. By contrast, the avatar_Network may be displayed in a mode where the avatar image is displayed based on the avatar skeleton model. However, both the avatar_Local and the avatar_Network may be displayed for the user 140. In the following description, it is assumed that the avatar images displayed for the users 140 and 150 are both avatar_Network.

As is apparent from the above description, the image generating system 100 according to the first embodiment preliminarily defines from-to rotation angle transition that gives wrong impression for each avatar body bone. The image generating system 100 according to the first embodiment determines whether the transition of the avatar body bone between the time t1 and the time t1+1 violates the from-to rotation angle transition that gives wrong impression. In addition, when the image generating system 100 according to the first embodiment determines that the transition of the avatar body bone between the time t1 and the time t1+1 does not violate the from-to rotation angle transition that gives wrong impression, the image generating system 100 generates the avatar image by reflecting a non-verbal behavior of the user at time t1+1. By contrast, when the image generating system 100 according to the first embodiment determines that the transition of the avatar body bone between the time t1 and the time t1+1 violates the from-to rotation angle transition that gives wrong impression, the image generating system 100 generates the avatar image by not reflecting the non-verbal behavior of the user as it is, but by reflecting the non-verbal behavior of the user in a range of not giving wrong impression at time t1+1.

As a result, an image that gives wrong impression to the counterpart person who sees the avatar may be prevented from being generated. In other words, generate an image that provides no wrong impression to a counterpart person who sees the avatar.

### Second Embodiment

The image generating system 100 in the first embodiment determines whether the transition of the avatar body bone between times t1 and t1+1 violates the from-to rotation angle transition definition that gives wrong impression, thereby avoiding generation of an image giving wrong impression to the counterpart person who sees the avatar.

In the second embodiment, generation of an image that gives wrong impression to the counterpart person who sees the avatar may be prevented by determining whether tendency of social behavior changes between time t1 and time t1+1.

In addition, social behavior refers to non-verbal behavior which human being performs against something social existence in real space.

For example, when it is assumed that a non-verbal behavior of a predetermined person is non-verbal behavior of moving forward, and there is another person in the place where the predetermined person moved forward, the non-verbal behavior of the predetermined person indicates social behavior of approaching the other person (social behavior indicating approaching tendency). By contrast, when it is assumed that a non-verbal behavior of a predetermined person is moving away from another person as a result of performing non-verbal behavior of moving forward in a condition of the other person being nearby, the non-verbal behavior of the predetermined person indicates social behavior of moving away from the other person (social behavior indicating avoiding tendency). Likewise, when it is assumed that a non-verbal behavior of a predetermined person is non-verbal behavior of turning head orientation to the right, and there is another person on the right, the non-verbal behavior of the predetermined person indicates social behavior of facing the other person (social behavior indicating approaching tendency). By contrast, when it is assumed that a non-verbal behavior of a predetermined person is non-verbal behavior of turning head orientation to the right in a state where there is another person on the left, the non-verbal behavior of the predetermined person indicates social behavior of turning the predetermined person's face from the other person (social behavior indicating avoiding tendency).

Thus, “transition of avatar body bone” in virtual reality space may have opposite meaning depending on the relation with other avatars. The following mainly illustrates a second embodiment in which display of an image giving wrong impression is avoided by determining whether the tendency of social behavior of the user changes, which illustrates the difference between the first embodiment and second embodiment.

### Functional Configuration of Restricting Unit of Image Generating Apparatus

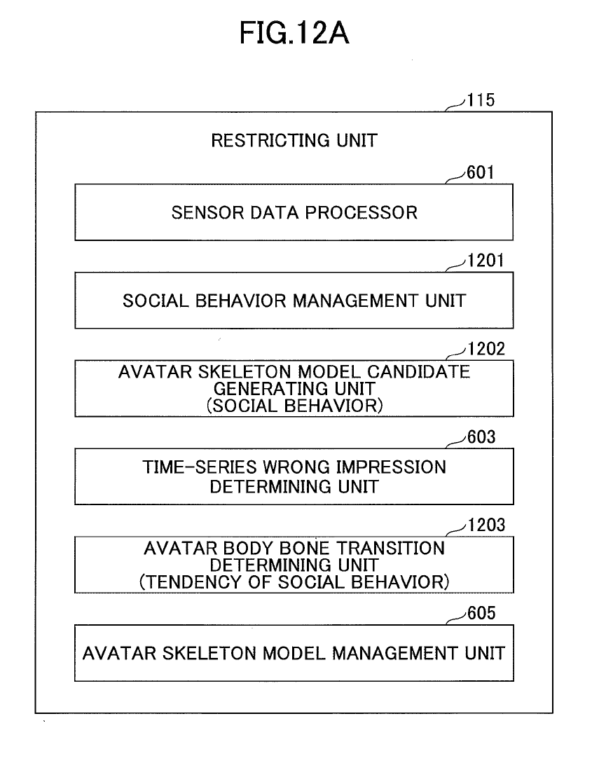

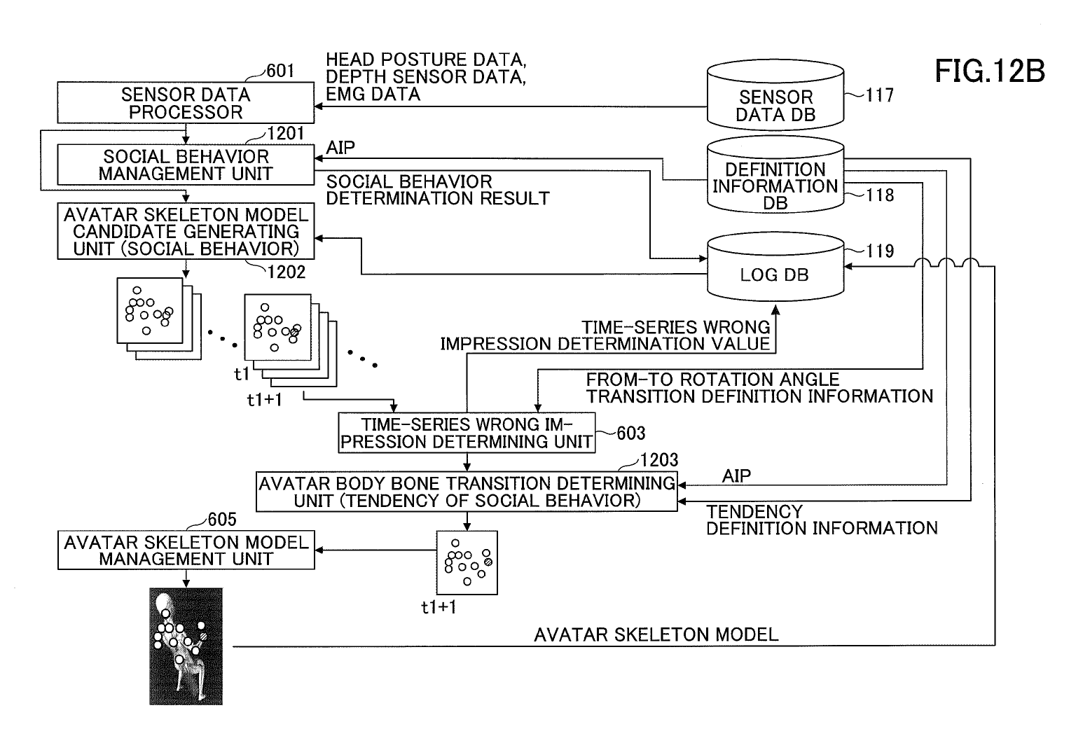

First, a description is given of a functional configuration of a restricting unit of the image generating apparatus in the second embodiment. FIGS. 12A and 12B are second diagrams illustrating a functional configuration of a restricting unit of the image generating apparatus. Of the elements illustrated in FIG. 12A, the same reference numerals are assigned to the elements having the same functions as the elements illustrated in FIG. 6A, and a description of these elements is omitted from the specification.

The difference between FIG. 12A and FIG. 6A is that in the configuration of FIG. 12A, the restricting unit 115 includes a social behavior management unit 1201, an avatar skeleton model candidate generating unit (social behavior) 1202, and an avatar body bone transition determining unit (tendency of social behavior) 1203.

As illustrated in FIG. 12B, the social behavior management unit 1201 determines social behavior based on sensor data in a predetermined time range read from the sensor data DB 117, and stores a social behavior determination result in the log DB 119.

The social behavior management unit 1201 calls an existing API from the social behavior determination API definition information (hereinafter referred to as “API definition information”) of the definition information DB 118 to determine a social behavior.

The social behavior management unit 1201 may determine one social behavior from one sensor data in a predetermined time range or one social behavior from multiple sensor data in the predetermined time range. In addition, the social behavior management unit 1201 may determine social behavior from sensor data in a newly acquired predetermined time range. Alternatively, social behavior may be determined using sensor data in a previously recorded predetermined time range and sensor data in a newly acquired predetermined time range.

The avatar skeleton model candidate generating unit (social behavior) 1202 reads the social behavior determination result stored in the log DB 119.

The avatar skeleton model candidate generating unit (social behavior) 1202 generates avatar skeleton model candidates based on the read social behavior determination result. Specifically, the avatar skeleton model candidate generating unit (social behavior) 1202 identifies the time range used for determining social behavior. In addition, the avatar skeleton model candidate generating unit (social behavior) 1202 generates avatar skeleton model candidates based on the sensor data sensed in the identified time range.

In the second embodiment, among the avatar skeleton model candidates generated at this time, the avatar skeleton model candidate at the time at which social behavior starts is set as the avatar skeleton model candidate generated based on the sensor data at time t1. Further, the avatar skeleton model candidate at the time at which social behavior is completed is set as avatar skeleton model candidate generated based on the sensor data at time 1+1.

The avatar body bone transition determining unit (tendency of social behavior) 1203 determines transition of each avatar body bone between time t1 and time t1+1 based on the time-series wrong impression determination value determined by the time-series wrong impression determining unit 603.

When the avatar body bone transition determining unit (tendency of social behavior) 1203 determines that all the avatar body bones do not give wrong impression, the avatar body bone transition determining unit 604 determines to reflect all the avatar body bones at the time t1+1 in the avatar skeleton model.

When the avatar body bone transition determining unit (tendency of social behavior) 1203 determines that a part of the avatar body bones gives wrong impression, the avatar body bone transition determining unit 604 determines not to reflect the part of the avatar body bones at the time t1+1 in the avatar skeleton model. In this case, the avatar body bone transition determining unit (tendency of social behavior) 1203 determines the transition of the avatar body bone between the time t1 and the time t1+1 within a range that does not give wrong impression. However, the avatar body bone transition determining unit (tendency of social behavior) 1203 refers to the tendency definition information (details will be described later) stored in the definition information DB 118 and determines the transition of each of the avatar body bones at time t1+1 within a range of not changing the tendency of social behavior.

### Definition Information Stored in Definition Information DB

Next, of the definition information stored in the definition information DB 118 in the second embodiment, “API definition information” and “tendency definition information” will be described. Note that the from-to rotation angle transition definition information 800 has already been described in the first embodiment, and a duplicated description is thus omitted.

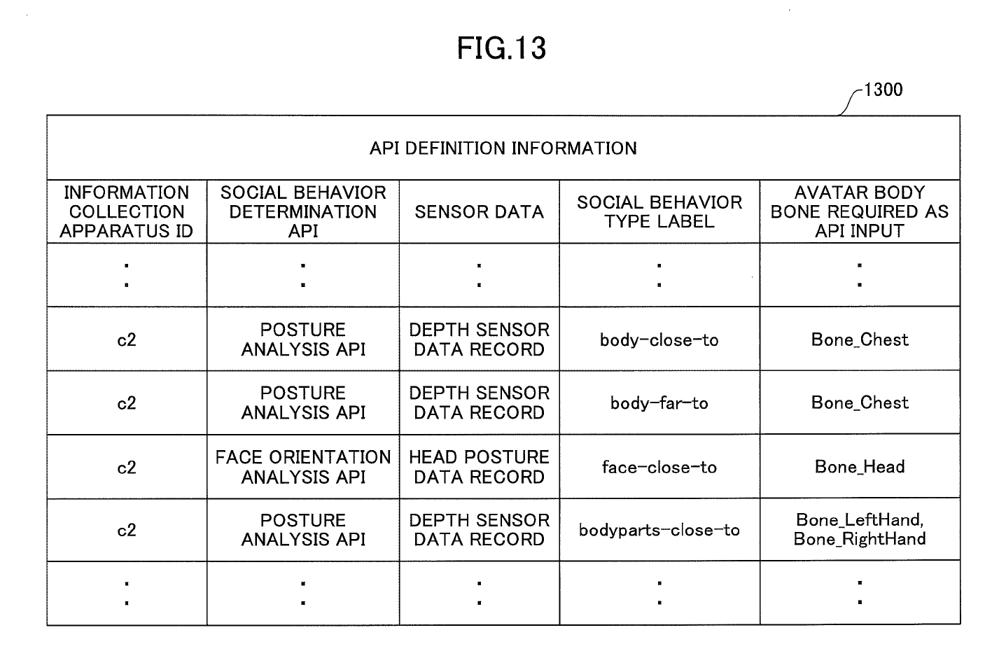

FIG. 13 is a diagram illustrating an example of API definition information stored in the definition information DB. As illustrated in FIG. 13, the API definition information 1300 includes “information collection apparatus ID”, “social behavior determination API”, “sensor data”, “social behavior type label”, and “avatar body bone required as an API input” as information items.

The “information collection apparatus ID” stores an identifier indicating a type of the information collection apparatus. The “social behavior determination API” stores an API used for determining social behavior.

The “sensor data” stores a type of sensor data input to the social behavior determination API.

The “social behavior type label” stores a type of social behavior determined by the social behavior determination API. The “avatar body bone required as an API input” stores an avatar body bone to be input in the API when determining the social behavior using the social behavior determination API.

The first line of the data row in FIG. 13 indicates that the depth data sensed by the depth sensor 125 specified by the information collection apparatus ID=“c2” is input to “posture analysis API”. In addition, the example of the first line of the data row in FIG. 13 indicates that whether the social behavior of the user 140 corresponds to “body-close-to” is determined. Further, the example of the first line of the data row in FIG. 13 indicates that the avatar body bone=“Body-Chest” is used when determining the social behavior of the avatar body bone candidate for determining the time-series wrong impression determination value.

The second line of the data row in FIG. 13 indicates that the depth data sensed by the depth sensor 125 specified by the information collection apparatus ID=“c2” is input to “posture analysis API”. In addition, the example of the second line of the data row in FIG. 13 indicates that whether the social behavior of the user 140 corresponds to “body-far-to” is determined. Further, the example of the second line of the data row in FIG. 13 indicates that the avatar body bone=“Bone-Chest” is used when determining the social behavior of the avatar body bone candidate for determining the time-series wrong impression determination value.

The third line of the data row in FIG. 13 indicates that the head posture data sensed by the head posture sensor 124 specified by the information collection apparatus ID=“c1” is input to “face orientation analysis API”. In addition, the example of the third line of the data row in FIG. 13 indicates that whether the social behavior of the user 140 corresponds to “face-close-to” is determined. Further, the example of the third line of the data row in FIG. 13 indicates that the avatar body bone=“Bone-Head” is used when determining the social behavior of the avatar body bone candidate for determining the time-series wrong impression determination value.

The fourth line of the data row in FIG. 13 indicates that the depth data sensed by the depth sensor 125 specified by the information collection apparatus ID=“c2” is input to “posture analysis API”. In addition, the example of the fourth line of the data row in FIG. 13 indicates that whether the social behavior of the user 140 corresponds to “bodyparts-close-to” is determined. Further, the example of the fourth line of the data row in FIG. 13 indicates that the avatar body bone=“Bone-LeftHand” and “Bone-RightHand” is used when determining the social behavior of the avatar body bone candidate for determining the time-series wrong impression determination value.

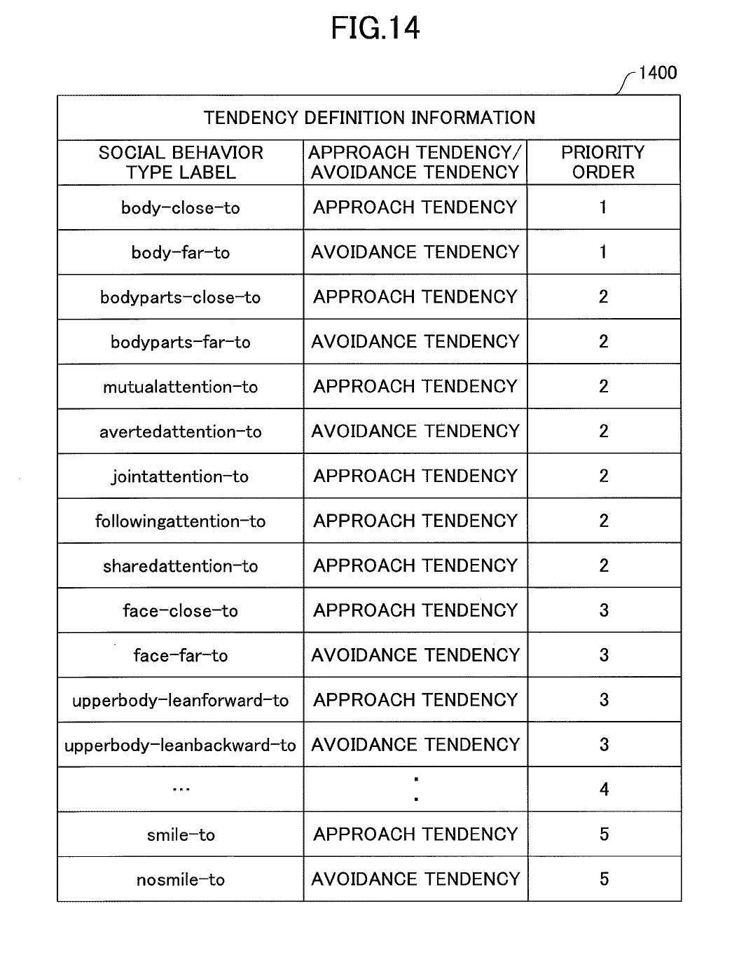

FIG. 14 is a diagram illustrating an example of tendency definition information stored in the definition information DB. As illustrated in FIG. 14, the tendency definition information 1400 includes “social behavior type label”, “approach tendency/avoidance tendency”, and “priority order” as information items.

The “social behavior type label” stores a type of social behavior. The “approach tendency/avoidance tendency” stores approach tendency or avoidance tendency for each type of social behavior. The “priority order” stores the priority order assigned to types of movement for social behavior. Note that the record stored in the “social behavior type label” of the tendency definition information 1400 indicates the following actions.

For example, “body-close-to” indicates an action to move the body closer to a counterpart person, and “body-far-to” indicates an action to move the body away from the counterpart person. Further, “bodyparts-close-to” indicates an action to move parts of the body closer to the counterpart person, and “bodyparts-far-to” indicates an action to move parts of the body away from the counterpart person.

In addition, “mutualattention-to” indicates an action to see each other, and “averted attention-to” indicates an action to remove a line of sight from the counterpart person. In addition, “Jointattention-to” indicates an action to see the same thing as the counterpart person, and “followingattention-to” indicates an action to see by following with one's eye what the counterpart person is seeing. Moreover, “sharedattention-to” indicates an action to see the same thing as the counterpart person is seeing while knowing it about each other.

Further, “face-close-to” indicates an action to move a user's face closer to the counterpart person, and “face-far-to” indicates an action to move the user's face away from the counterpart person. In addition, “upperbody-leanforward-to” indicates an action to cause the body to lean forward, and “upperbody-leanbackward-to” indicates an action to cause the body to lean backward.

Furthermore, “smile-to” indicates an action to smile, and “nosmile-to” indicates an action not to smile.

Actions other than those illustrated in the tendency definition information 1400 of FIG. 14 may be stored in the tendency definition information 1400 as behaviors of approach tendency or behaviors of avoidance tendency. For example, behaviors of approaching tendency include an action to direct the user's face toward the counterpart person's side or an action to direct the user's body toward the counterpart person's side. Likewise, behaviors of avoidance tendency include an action to turn the user's face away from the counterpart person or an action to turn the user's body away from the counterpart person.

### Avatar Skeleton Model Updating Process

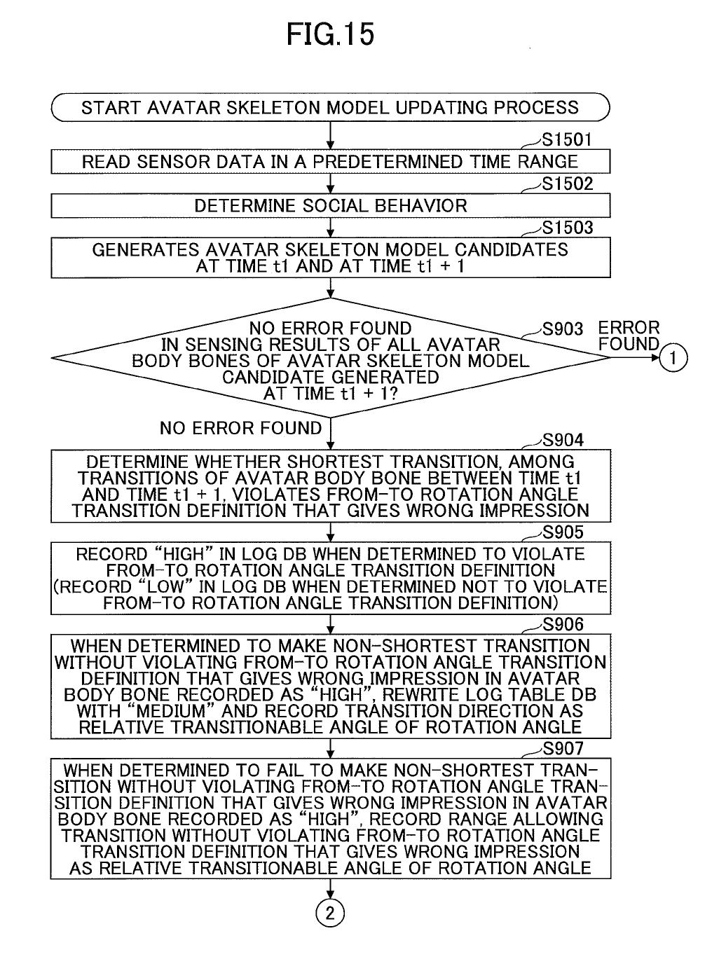

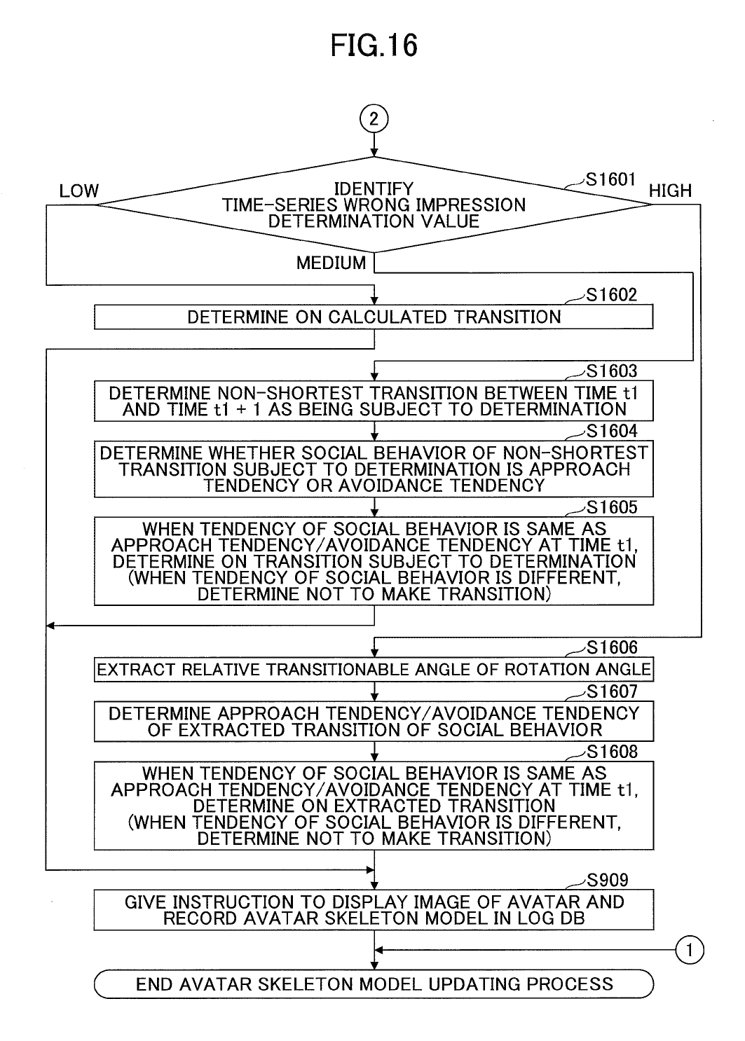

Next, a description is given of a flow illustrating an avatar skeleton model updating process performed by the restricting unit 115. FIGS. 15 and 16 are second and third flowcharts of the avatar skeleton model updating process. The difference from the first flowchart illustrated in FIG. 9 is to execute steps S1501 to S1503 in FIG. 15. In addition, the difference from the first flowchart is to execute steps S1601 to S1608 in FIG. 16 instead of executing step S908 in FIG. 9.

In step S1501 of FIG. 15, the sensor data processor 601 reads sensor data in a predetermined time range from the sensor data DB 117.

In step S1502, the social behavior management unit 1201 determines social behavior based on the sensor data in the predetermined time range read in step S1501, and stores a social behavior determination result in the log DB 119.

In step S1503, the avatar skeleton model candidate generating unit (social behavior) 1202 generates the avatar skeleton model candidates at time t1 and at time t1+1 based on the sensor data sensed in the time range used for determining the social behavior.

In step S1601 of FIG. 16, the social behavior management unit 1201 identifies the time-series wrong impression determination value on each avatar body bone on which the processes in steps S904 to S907 in FIG. 15 have been performed. In step S1601, with respect to the avatar body bone determined to have the time-series wrong impression determination value “low”, the transition of the avatar body bone is determined in step S1602. Specifically, in step S1602, the avatar body bone transition determining unit (tendency of social behavior) 1203 determines the transition of the avatar body bone calculated when the avatar skeleton model candidate is generated in step S1503 to be the transition of the avatar body bone at time t1+1.

By contrast, in step S1601, with respect to the avatar body bone determined to have the time-series wrong impression determination value “medium”, the transition of the avatar body bone is determined in steps S1603 to S1605. Specifically, in step S1603, the social behavior management unit 1201 determines a non-shortest transition between time t1 and time t1+1 as being subject to determination.

In step S1604, the social behavior management unit 1201 determines whether the social behavior of the non-shortest transition subject to determination in step S1603 is approach tendency or avoidance tendency.

Furthermore, in step S1605, the avatar body bone transition determining unit (tendency of social behavior) 1203 determines whether the tendency of social behavior determined in step S1604 is the same as the tendency of social behavior determined at time t1. When the avatar body bone transition determining unit 1203 determines that the tendency of social behavior determined in step S1604 is the same as the tendency of social behavior determined at time t1, the avatar body bone transition determining unit (tendency of social behavior) 1203 determines the transition (non-shortest transition) subject to determination in step S1603 as the transition of the avatar body bone. By contrast, when the avatar body bone transition determining unit 1203 determines that the tendency of social behavior determined in step S1604 differs from the tendency of social behavior determined at time t1, the avatar body bone transition determining unit (tendency of social behavior) 1203 determines not to reflect the transition of the avatar body bone at time t1+1.

Further, in step S1601, with respect to the avatar body bone determined to have the time-series wrong impression determination value “high”, the transition of the avatar body bone is determined in steps S1606 to S1608. Specifically, in step S1606, the social behavior management unit 1201 extracts the relative variation recorded in the “relative transitionable angle of a rotation angle” of the determination value log DB table 1000.

In step S1607, the social behavior management unit 1201 determines whether the social behavior of the transition based on the relative transitionable angle of a rotation angle extracted in step S1606 is approaching tendency or avoidance tendency.

Furthermore, in step S1608, the avatar body bone transition determining unit (tendency of social behavior) 1203 determines whether the tendency of social behavior determined in step S1607 is the same as the tendency of social behavior determined at time t1. When the avatar body bone transition determining unit 1203 determines that the tendency of social behavior determined in step S1607 is the same as the tendency of social behavior determined at time t1, the avatar body bone transition determining unit (tendency of social behavior) 1203 determines the transition based on the relative transitionable angle of a rotation angle extracted in step S1606 as the transition of the avatar body bone. By contrast, when the avatar body bone transition determining unit 1203 determines that the tendency of social behavior determined in step S1607 differs from the tendency of social behavior determined at time t1, the avatar body bone transition determining unit (tendency of social behavior) 1203 determines not to reflect the transition of the avatar body bone at time t1+1.

### Information Recorded in Log DB

Next, a description is given of information that is recorded in the log DB 119 by executing an avatar skeleton model updating process. Note that the following describes a table (social behavior log DB table) other than the tables that have been described in the first embodiment.

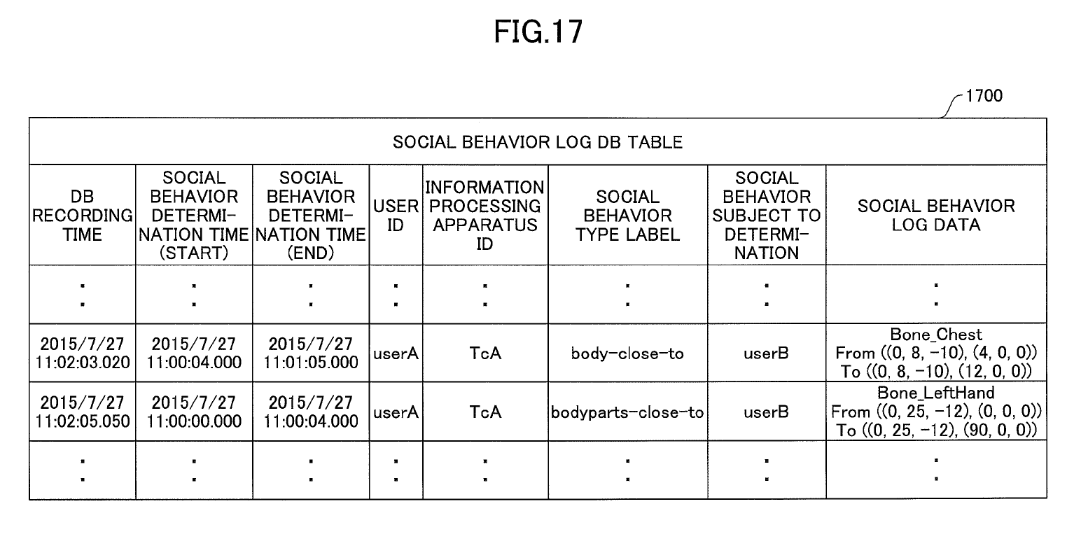

FIG. 17 is a diagram illustrating an example of a social behavior log DB table. As illustrated in FIG. 17, the social behavior log DB table 1700 includes information items such as “DB recording time”, “social behavior determination time (start)”, “social behavior determination time (end)”, and “user ID”. The social behavior log DB table 1700 further includes information items such as “information processing apparatus ID”, “social behavior type label”, “social behavior subject to determination”, and “social behavior log data”.

The “DB recording time” stores a time stamp added when the social behavior log data is recorded in the social behavior log DB table 1700.

The “social behavior determination time (start)” and “social behavior determination time (end)” store a time when the user has started social behavior and a time when social behavior started by the user has ended, respectively. Specifically, the “social behavior determination time (start)” and “social behavior determination time (end)” record respective time stamps added to the first and last sensor data of the sensor data in a predetermined time range, which are used when determining that social behavior has been performed. The depth data include a time stamp added to the first and last depth data included in the depth sensor data file used when determining that social behavior has been performed. However, when the depth sensor data file is long, the depth data may include the time at which the social behavior has started and the time at which the social behavior has ended that are accurately specified based on the time stamp of the depth data actually used for generating the social behavior log data.

The social behavior management unit 1201 generates social behavior log data at time t1+1 by using the sensor data within a time range (time t1+1−k to t1+1) from time t1+1 to time t1+1−k obtained by tracing from the sensor data sensed at time t1+1 back to a predetermined time k. Accordingly, to generate social behavior log data using the depth data, the social behavior management unit 1201 extracts sensor data by tracing from a sensor recording end time=“2015/7/27 11:01:05.000” (see FIG. 7C) back to a predetermined time k, for example. Subsequently, the social behavior management unit 1201 determines the social behavior at that time based on the extracted sensor data.

The “user ID” includes an identifier for identifying a user. The “information processing apparatus ID” includes an identifier of an information processing apparatus.

The “social behavior type label” stores information indicating a type of social behavior. The “social behavior subject to determination” includes an identifier that identifies a user who has performed social behavior subject to determination.

The “social behavior log data” includes the social behavior subject to determination performed by the user.

The example of the first line of the data row in FIG. 17 illustrates that the user 140 has determined to have performed social behavior of the type “body-close-to” with respect to the user 150. Note that the example of the first line of the data row in FIG. 17 simultaneously records the transition of the avatar body bone represented as the social behavior performed by the user 140. Specifically, the social behavior performed by the user 140 is represented such that the skeleton (Bone_Chest) of the waist of the avatar of the user 140 is rotated by +6 [degrees] from 4 [degrees] to 10 [degrees] with respect to the X axis without changing the position.

### FIRST EXAMPLE

As a first example of the avatar skeleton model updating process in the second embodiment, a description is given of a case where the time-series wrong impression determination value is determined to be “medium”. In the first example, it is assumed that the time-series wrong impression determination value of the bone of the avatar's left hand is determined to be “medium” in the following conditions.

The avatar of the user 150 resides on the right side of the avatar of the user 140.
The left hand of the avatar of the user 140 extends to an avatar-facing side of the user 150 at time t1+1.
At this time, the avatar skeleton model candidate having the orientation of the palm of the avatar of the user 140 being twisted toward a front direction of the user 140 and not directed toward the avatar of the user 150 is generated.

In this case, the transition of the bone of the left hand of the avatar between time t1 and time t1+1 is determined by the time-series wrong impression determining unit 603 to be “medium” for the time-series wrong impression determination value on the Y axis. The social behavior management unit 1201 determines a non-shortest transition subject to determination. Specifically, the social behavior management unit 1201 determines a transition from ((5, 25, −12), (0, 0, 0)) to ((10, 25, −12), (0, 170, 0)) to be subject to determination, as the non-shortest transition of avatar body bone=Bone_LeftHand (avatar's left hand bone).

The social behavior management unit 1201 determines social behavior with respect to the transition subject to determination that is not the shortest. In this case, the social behavior is determined with respect to the transition of the avatar body bone=Bone_LeftHand (bone of the left hand of avatar) from ((0, 25, −12), (4, 0, 0)) to ((10, 25, −12), (0, 170, 0)).

Among the social behavior determination APIs stored in the API definition information 1300, “posture analysis API” that inputs “Bone_LeftHand” is used for determining the social behavior.

One social behavior determination API outputs multiple social behavior type labels. In this case, it is assumed that “bodyparts-close-to” is output as a social behavior type label for the non-shortest transition of the bone of the avatar's left hand.

When the social behavior type label is output, the avatar body bone transition determining unit (tendency of social behavior) 1203 refers to the tendency definition information 1400 to determine that the tendency corresponding to “bodyparts-close-to” is “approach tendency”.

Note that when the tendency of social behavior determined at time t1 is “avoidance tendency”, the tendency of social behavior determined at time t1 differs from the tendency of social behavior determined at time t1+1. In this case, an avatar image obtained by reflecting the transition of the bone of the left hand of the avatar may give wrong impression to other users.

Hence, the avatar body bone transition determining unit (tendency of social behavior) 1203 maintains the bone of the left hand of the avatar at time t1 without reflecting the transition of the bone of the left hand of the avatar to the avatar image.

### SECOND EXAMPLE

As a second example of the avatar skeleton model updating process in the second embodiment, a description is given of a case where the time-series wrong impression determination value is determined to be “high”. In the first example, it is assumed that the time-series wrong impression determination value of the bone of the avatar's left hand is determined to be “medium” in the following conditions.

An avatar skeleton model candidate that bends a wrist 90 degrees with respect to the X axis from a state where a palm of his/her left hand is directed toward the front of himself/herself is generated at time t1+1.
From-to rotation angle transition definition (X axis) that gives wrong impression is 40<X<220.

In this case, the transition of the bone of the left hand of the avatar between time t1 and time t1+1 is determined by the time-series wrong impression determining unit 603 to be “high” for the time-series wrong impression determination value on the X axis. Accordingly, the social behavior management unit 1201 calculates a relative transitionable angle of a rotation angle. The relative transitionable angle of a rotation angle calcuated at this time is “+40 [degrees]” with respect to the X axis.

The social behavior management unit 1201 determines social behavior with respect to the extracted relative transitionable angle of a rotation angle. For example, the social behavior is determined with respect to the transition of the avatar body bone=Bone_LeftHand (bone of the left hand of avatar) from ((5, 25, −12), (0, 0, 0)) to ((5, 25, −12), (40, 0, 0)).

The determination of the social behavior is the same as when the time-series wrong impression determination value is determined to be “medium”, and when the social behavior determination API outputs the social behavior type label, the avatar body bone transition determining unit (tendency of social behavior) 1203 refers to the tendency definition information 1400.

Thus, the avatar body bone transition determining unit (tendency of social behavior) 1203 determines whether the social behavior type label is approach tendency or avoidance tendency. When the determination result indicates that the tendency of social behavior is not changed from the tendency determined at time t1, the avatar body bone transition determining unit (tendency of social behavior) 1203 determines the transition based on the relative variation (“+40 [degrees]”) to be a transition of the bone of the left hand of the avatar at time t1+1.

Note that when the time-series wrong impression determination value is “medium” or “high”, the actual avatar skeletal transition may be reduced; for example, the actual avatar skeletal transition may be set to be half of the relative transitionable angle of a rotation angle.

As is apparent from the above description, when the image generating system 100 according to the second embodiment determines that the transition of the bone of the avatar between time t1 and time t1+1 violates the from-to rotation angle transition that gives wrong impression, the image generating system 100 determines whether the tendency of behavior changes. Further, when the image generating system 100 according to the second embodiment determines that the tendency of social behavior changes, the image generating system 100 will not reflect the non-verbal behavior of the user to the transition of the avatar body bone at time t1+1. When the image generating system 100 according to the second embodiment determines that the tendency of social behavior does not change, the image generating system 100 generates an avatar image by reflecting the non-verbal behavior of the user to the transition of the avatar body bone within a range that does not give wrong impression.

As a result, a transition that changes the tendency of social behavior will not be generated, which makes it possible to avoid generation of an image that gives wrong impression to the counterpart person who sees the avatar. In other words, an image that provides no wrong impression to the counterpart person who sees the avatar may be generated.

### Third Embodiment

The first embodiment is described on the basis of assumption in which a from-to rotation angle transition definition that gives wrong impression is defined for each avatar body bone, and the time-series wrong impression determining unit determines the time series wrong impression determination value for each avatar body bone. However, the avatar body bone may still give wrong impression as the user's movement even when the avatar body bone does not violate the from-to rotation angle transition definition that gives wrong impression as the unit of in the avatar body bone.

For example, an illustration is given of a case where the rotation angle of the right hand bone of the avatar with respect to the X axis changes from 0 [degrees] to 270 [degrees] during time t1 and time t1+1. This example corresponds to a case where the user moves his/her palm towards the front of himself/herself and moves the wrist 90 [degrees] in a − direction of his own body from the state (0 [degrees]) where his/her fingertip is extended straight upward.

Since the action of such a user is assumed as an action of scratching the head and an action of grabbing the object, the action will not be defined as a from-to rotation angle transition definition that gives wrong impression as the unit of the avatar body bone.

However, in the communication scenes with other users, for example, the above-mentioned user's movement from a state in which the user bends and raises his/her elbow may give wrong impression to the other users.

In the third embodiment, even in such a case, the avatar skeleton model updating process is performed so as not to generate an image giving wrong impression to other users. In the following, the third embodiment will be described focusing on differences from the first embodiment.

### Functional Configuration of Restricting Unit of Image Generating Apparatus

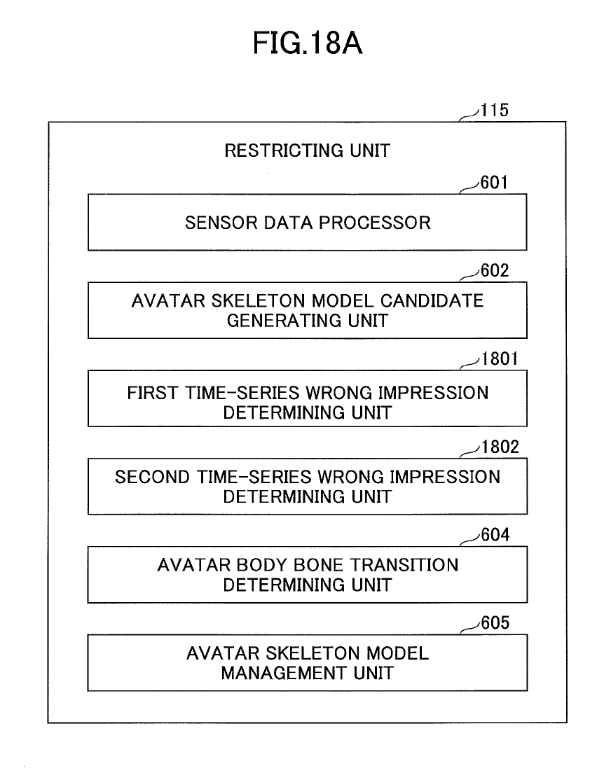

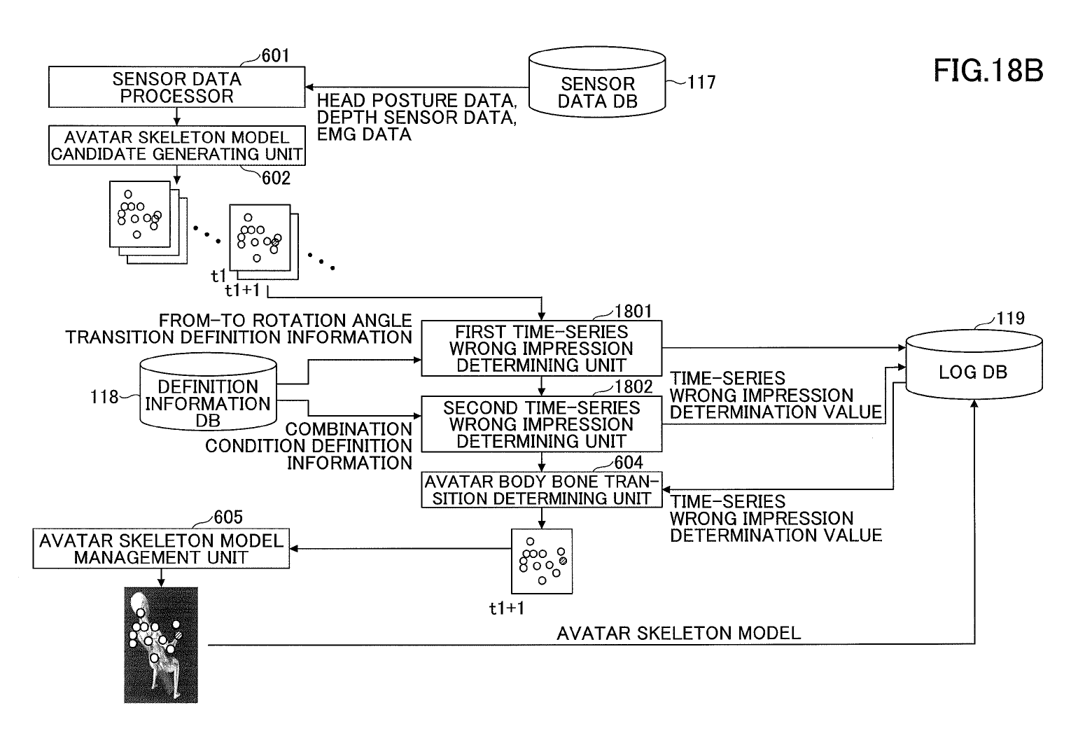

First, a description is given of a functional configuration of a restricting unit of the image generating apparatus in the third embodiment. FIGS. 18A and 18B are third diagrams illustrating a functional configuration of a restricting unit of the image generating apparatus. The difference between FIG. 6A and FIG. 18A is that in FIG. 18A, the restricting unit 115 includes a first time-series wrong impression determining unit 1801 and a second time-series wrong impression determining unit 1802.

The first time-series wrong impression determining unit 1801 has the same function as the time-series wrong impression determining unit 603. That is, the first time-series wrong impression determining unit 1801 determines whether each of the avatar skeleton model candidates generated by the avatar skeleton model candidate generating unit 602 gives wrong impression due to the transition between time t1 and time t1+1. The first time-series wrong impression determining unit 1801 determines whether each of the avatar skeleton model candidates gives wrong impression by referring to the from-to rotation angle transition definition information 800 stored in the definition information DB 118. In addition, the first time-series wrong impression determining unit 1801 records the time-series wrong impression determination value and the like of each avatar body bone in the determination value log DB table 1000 based on the corresponding determination result.

The second time-series wrong impression determining unit 1802 extracts the avatar body bone determined to be “low” by the first time-series wrong impression determining unit 1801 among the avatar body bones of the avatar skeleton model candidate generated by the avatar skeleton model candidate generating unit 602.

The second time-series wrong impression determining unit 1802 determines whether to rewrite the time-series wrong impression value with respect to the avatar body bone having the time-series wrong impression determination value determined to be “low”, by referring to the combination condition definition information of the from-to rotation angle transitions that give wrong impression (hereinafter referred to as “combination condition definition information”, details will be described later) stored in the definition information DB 118. The second time-series wrong impression determining unit 1802 determines whether to rewrite the time-series wrong impression determination value by determining whether the extracted avatar body bone matches the “conditions to be combined” specified in the combination condition definition information. Note that the term “conditions to be combined” indicates a condition that is determined to give wrong impression by combining with a from-to rotation angle transition definition specified for each avatar body bone.

As described above, the second time-series wrong impression determining unit 1802 rewrites the time-series wrong impression determination value even when the avatar body bone does not violate the from-to rotation angle transition definition that gives wrong impression as the unit of the avatar body bone, but the avatar body bone still gives wrong impression as a transition of the avatar body bone. As a result, the possibility of generating an image that gives wrong impression to the counterpart person who sees the avatar may be reduced.

### Description of Combination Condition Definition Information

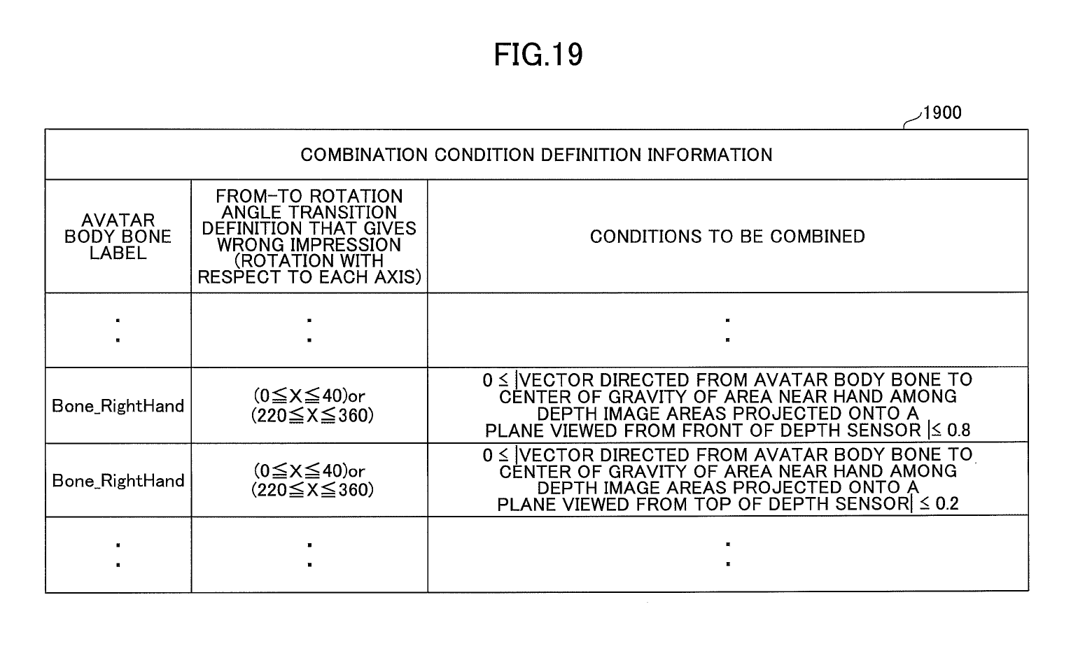

Next, the combination condition definition information referred to by the second time-series wrong impression determining unit 1802 will be described. FIG. 19 is a diagram illustrating an example of combination condition definition information.

As illustrated in FIG. 19, the combination condition definition information 1900 includes “avatar body bone label”, “from-to rotation angle transition definition (disorientation with each axis)” and “conditions to be combined” as items of information.

The “avatar body bone label” stores information identifying one of the multiple avatar body bones included in the avatar skeleton model candidate.

The “from-to rotation angle transition definition that gives wrong impression (rotation with respect to each axis)” stores information indicating from-to rotation angle transition to be determined as to whether wrong impression is given in a rotation of each avatar body bone with respect to each axis. Note that a range defined by the “from-to rotation angle transition definition that gives wrong impression (rotation with respect to each axis)” of the combination condition definition information 1900 does not match a range defined by the “from-to rotation angle transition definition that gives wrong impression” of the from-to rotation angle transition definition information 800. The second time-series wrong impression determining unit 1802 is used for determining the presence or absence of wrong impression in a range that does not fall within the range determined by the first time-series wrong impression determining unit 1801.

Note that the range defined by the “from-to rotation angle transition definition that gives wrong impression (rotation with respect to each axis)” of the combination condition definition information 1900 may be partially matched with the range defined in by the “from-to rotation angle transition definition that gives wrong impression” of the from-to rotation angle transition definition information 800.

The “conditions to be combined” are defined as conditions determined to give wrong impression in combination with the “from-to rotation angle transition definition that gives wrong impression” in the combination condition definition information 1900. The conditions to be combined are each a functionalized value in the system and will be described in detail below.

### Conditions to be Combined

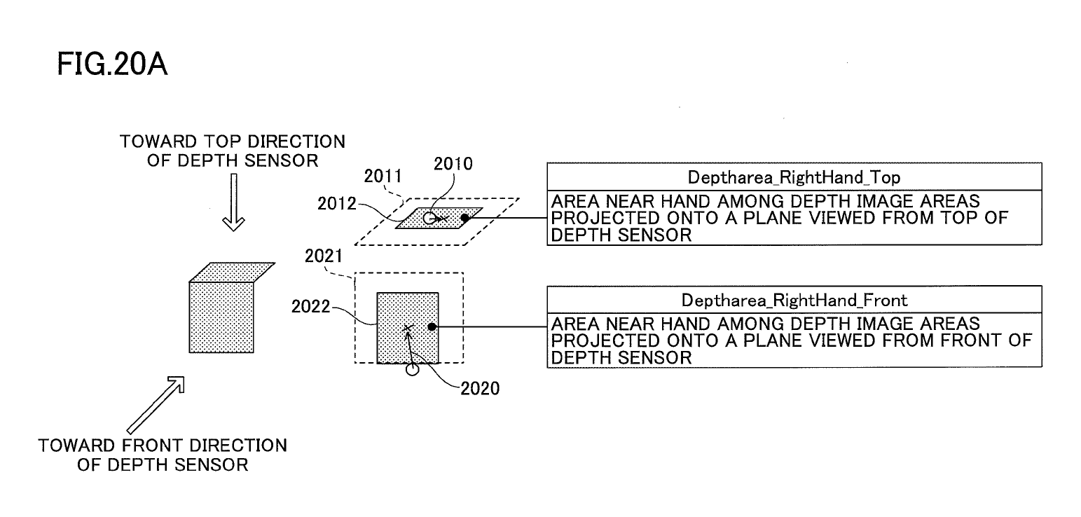

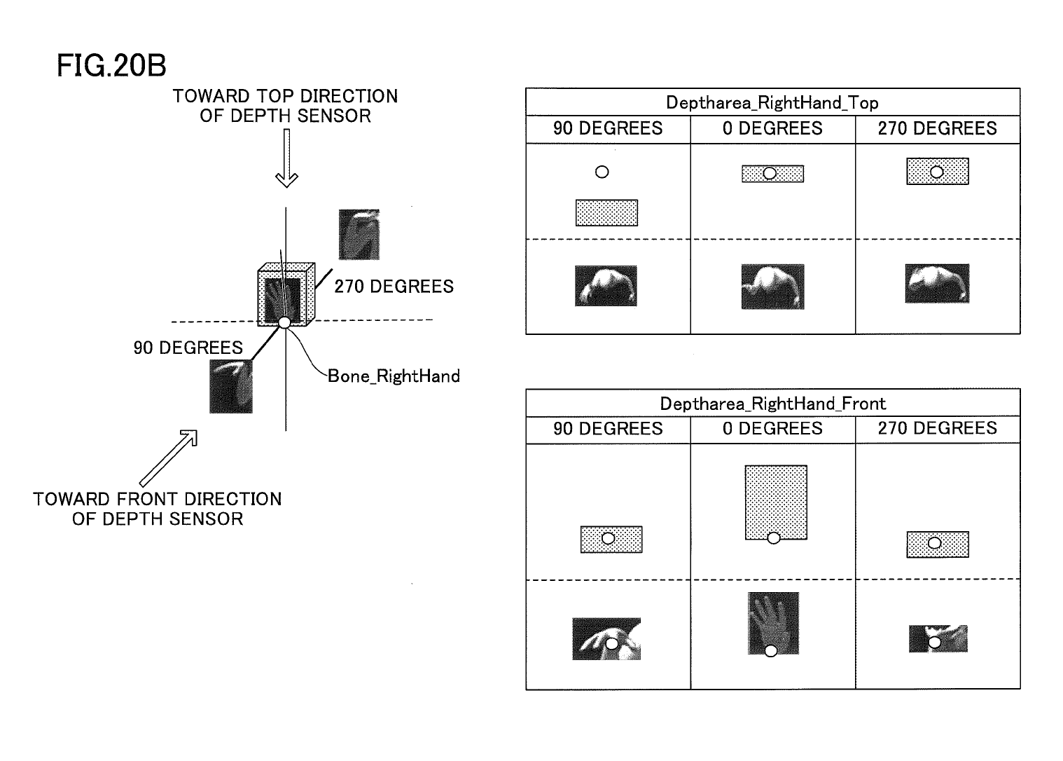

FIGS. 20A and 20B are diagrams illustrating conditions to be combined. Of these, FIG. 20A includes diagrams illustrating “the area near the hand among depth image areas projected onto a plane viewed from the front of the depth sensor” and “the area near the hand among depth image areas projected onto a plane viewed from the top of the depth sensor” described in the “conditions to be combined”.

In FIG. 20A, an area 2021 indicates the area near the hand among depth image areas projected onto a plane viewed from the front of the depth sensor, and an area 2022 indicates the area near the hand. In addition, a cross mark “x” in the area 2022 indicates the center of gravity of the area 2022, and a circle mark “∘” in the area 2021 indicates a position obtained by projecting the hand of the avatar body bone onto the plane of the area 2021. In other words, in a case of the avatar body bone's right hand, the “vector directed from the avatar body bone to the center of gravity of the area near the hand among depth image areas projected onto a plane viewed from the front of the depth sensor” indicates the vector 2020 illustrated in FIG. 20A.

Similarly, an area 2011 indicates the area near the hand among depth image areas projected onto a plane viewed from the top of the depth sensor, and an area 2012 indicates the area near the hand. In addition, a cross mark “x” in the area 2012 indicates the center of gravity of the area 2012, and a circle mark “∘” in the area 2011 indicates a position obtained by projecting the hand of the avatar body bone onto the plane of the area 2011. In other words, the “vector directed from the avatar body bone to the center of gravity of the area near the hand among the image areas projected onto a plane viewed from the top of the depth sensor” indicates the vector 2010 illustrated in FIG. 20A.

The transition having the length of the vector 2020 being 0 or more and 0.8 or less derives from the movement of bending the wrist forward or backward as viewed from the user facing the front of the depth sensor in the avatar body bone. The transition having the length of the vector 2010 being 0 or more and 0.2 or less derives from the movement of bending the wrist forward or backward as viewed from the user facing the top of the depth sensor. Specifically, the transition having the length of the vector 2010 being 0 or more and 0.2 or less results from the movement of the user's bending the wrist of the avatar body bone to position the fingertip of the hand behind the position of the wrist. In other words, as illustrated in FIG. 20B, in a case where the rotation angle of the right wrist with respect to the X axis transitions from 0 [degrees] to 90 [degrees] (a case of bending the right wrist forward to move the fingertip forward) does not correspond to the transition having the length of the vector 2010 being 0 or more and 0.2 or less.

As described above, the first condition (the transition having the length of the vector 2020 being 0 or more and 0.8 or less) defined in the “conditions to be combined” defines the transition of the vector length generated by the movement of bending the wrist forward or backward. As described above, the second condition (the transition having the length of the vector 2010 being 0 or more and 0.2 or less) defined in the “conditions to be combined” may define, for example, the transition of the vector length generated by the movement of bending the wrist backward among the movements of the user defined by the first condition in the “combination condition”.

Hence, the following illustrates a case where the first condition and second condition are both satisfied when the user bends the elbow as viewed from the user facing the front of the depth sensor 125 and raises the palm toward the depth sensor 125. That is, the user bends the wrist of the right hand backward, for example, and the rotation angle of the right hand bone of the avatar transitions from 0 [degrees] to 270 [degrees] with respect to the X axis.

As a result, according to the second time-series wrong impression determining unit 1802, such transition of the avatar's right hand bone having the time-series wrong impression determination value determined to be “low” in the first time-series wrong impression determining unit 1801 may have the time-series wrong impression determination value determined to be “high”.

Note that the area 2012 and the area 2022 in FIG. 20A are defined by the following procedure. First, the position coordinates of the right hand bone of the avatar are converted into position coordinates of the coordinate space of the depth sensor 125. Next, an area in which the user's hand may have been detected is determined based on the position coordinates of the avatar's right hand bone converted to the coordinate space of the depth sensor 125 as the center. More specifically, the area may be a hand area determined with a detailed algorithm for detecting flesh color pixels combined with the color image obtained from the depth sensor 125, or may be a hand area determined with an average hand size rectangular parallelepiped. Then, the area near the hand projected onto the plane viewed from the top of the depth sensor is defined as an area 2011, based on the depth data sensed in the determined area. Further, an area near the hand projected onto the plane viewed from the front of the depth sensor is defined as an area 2021. Note that the area 2012 and the area 2022 may be defined with other sensor data other than the depth data.

### Avatar Skeleton Model Updating Process

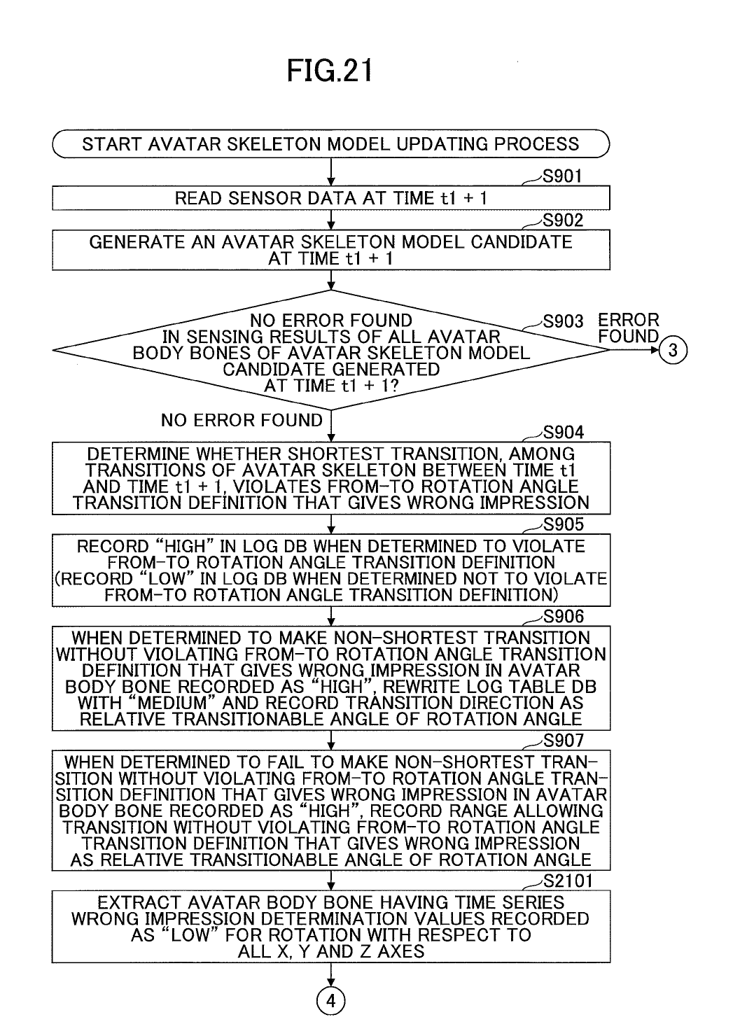

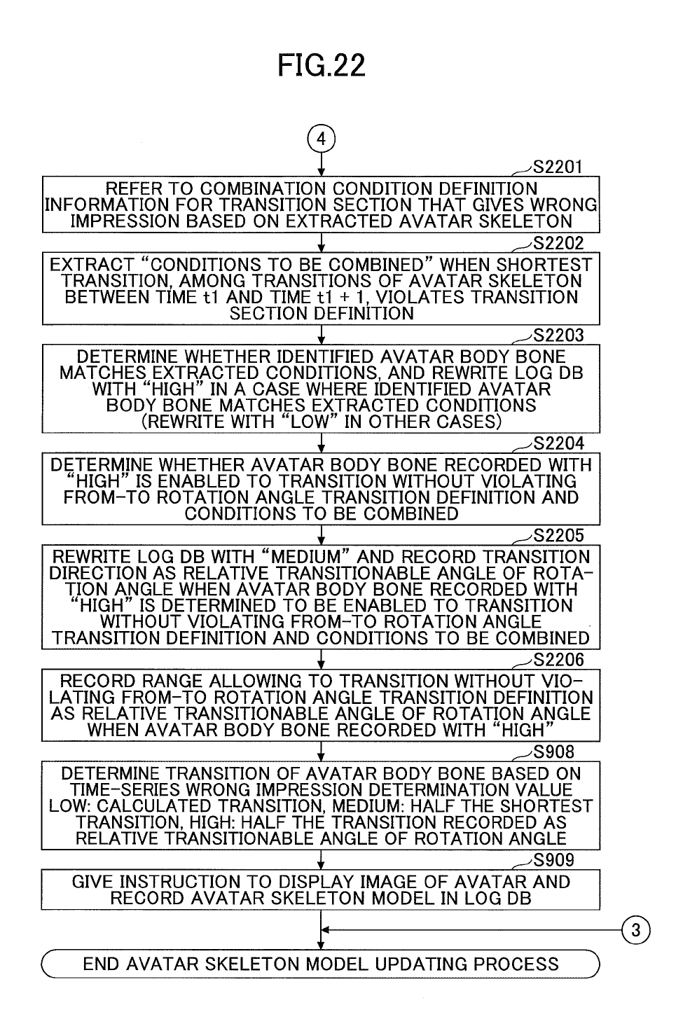

Next, a description is given of a flow illustrating an avatar skeleton model updating process performed by the restricting unit 115. FIGS. 21 and 22 are second and third flowcharts of the avatar skeleton model updating process. The difference from the first flowchart illustrated in FIG. 9 includes step S2101 in FIG. 21 and steps S2201 through S2206 in FIG. 22. Note that the following description focuses only on the right hand bone of the avatar. More specifically, a description is given by focusing on transition of the right hand bone of the avatar from the rotation angle with respect to the X axis of being 0 [degrees] at time t1 to the rotation angle with respect to the X axis being 270 [degrees] at time t1+1.

In step S2101 of FIG. 21, the second time-series wrong impression determining unit 1802 extracts the avatar body bone having the time-series wrong impression determination value recorded as “low” in the first time-series wrong impression determining unit 1801 (in this example, extracting the avatar's right hand bone).

In step S2201 of FIG. 22, the second time-series wrong impression determining unit 1802 refers to the combination condition definition information 1900 based on the avatar body bone extracted in step S2101. The second time-series wrong impression determining unit 1802 determines whether the transition of the extracted avatar body bone violates the “from-to rotation angle transition definition that gives wrong impression (rotation with respect to each axis)” in the combination condition definition information 1900. Since the shortest transition of the right hand bone of the avatar is 0 [degrees] to 270 [degrees], the transition of the extracted avatar body bone violates the “from-to rotation angle transition definition (the rotation with respect to each axis) that gives wrong impression” in the combination condition definition information 1900.

Note that whether the transition of the extracted avatar body bone violates the “from-to rotation angle transition definition that gives wrong impression (rotation with respect to each axis)” may be determined based on whether the shortest transition of the avatar body bone is completely included in the specified range or may be determined based on whether the shortest transition of the avatar body bone is partially included in the specified range.

In step S2202, the second time-series wrong impression determining unit 1802 extracts the “conditions to be combined” defined in association with the from-to rotation angle transition definition that gives wrong impression (rotation with respect to each axis)” determined as being violated in step S2201. Note that in this example, the second time-series wrong impression determining unit 1802 extracts two “conditions to be combined”.

In step S2203, the second time-series wrong impression determining unit 1802 determines whether the extracted avatar body bone matches the “conditions to be combined” extracted in step S2202.

When determining that the extracted avatar body bone matches the “conditions to be combined” extracted in step S2202, the second time-series wrong impression determining unit 1802 rewrites the “time-series wrong impression determination value” of the determination value log DB table 1000 with “high”.

In this case, a description is given with reference to an example in which the user 140 bends the elbow against the depth sensor 125 from the front and raises the palm toward the depth sensor 125. When the shortest transition of the right hand bone of the avatar is 0 [degrees] to 270 [degrees] (in a case of a movement in which the wrist is folded backward), the extracted avatar body bone is determined to match the conditions to be combined, and hence the second time-series wrong impression determining unit 1802 rewrites the “time-series wrong impression determination value” of the determination value log DB table 1000 with “high”.

In step S2204, the second time-series wrong impression determining unit 1802 extracts the avatar body bone recorded as “high” in the “time-series wrong impression determination value” of the determination value log DB table 1000 at this point.

The second time-series wrong impression determining unit 1802 refers to the combination condition definition information 1900 based on the extracted avatar body bone. The second time-series wrong impression determining unit 1802 determines whether the extracted avatar body bone is caused to change its angle of transition without violating the “from-to rotation angle transition definition (rotation with respect to each axis) that gives wrong impression” in the combination condition definition information 1900 and the “conditions to be combined”. In addition, the second time-series wrong impression determining unit 1802 determines whether the extracted avatar body bone is caused to change its angle of transition without violating the from-to rotation angle transition definition that gives wrong impression with respect to each axis.

In step S2205, the second time-series wrong impression determining unit 1802 is assumed to determine that the extracted avatar body bone is able to change its angle of transition without violating the “from-to rotation angle transition definition (rotation with respect to each axis) that gives wrong impression” in the combination condition definition information 1900 and the “conditions to be combined”. Further, the second time-series wrong impression determining unit 1802 is assumed to determine that the extracted avatar body bone is able to change its angle of transition without violating the from-to rotation angle transition definition that gives wrong impression with respect to each axis in step S2204. In that case, the second time-series wrong impression determining unit 1802 extracts the determined avatar body bone. Further, the second time-series wrong impression determining unit 1802 rewrites the “time-series wrong impression determination value” of the determination value log DB table 1000 with “medium”, with respect to the extracted avatar body bone.

Furthermore, the second time-series wrong impression determining unit 1802 determines a transition direction that allows transition without violating the from-to rotation angle transition definition that gives wrong impression with respect to each axis, in addition to the from-to rotation angle transition definition that gives wrong impression (rotation with respect to each axis) and the “conditions to be combined”. The second time-series wrong impression determining unit 1802 records the determined transition direction in the “relative transitionable angle of a rotation angle” of the determination value log DB table 1000.

In step S2206, the second time-series wrong impression determining unit 1802 extracts the avatar body bones having the not rewritten time series wrong impression determination value among the avatar body bones (the avatar body bone having the time series wrong impression determination value recorded as “high”) extracted in step S2204.

The second time-series wrong impression determining unit 1802 records a range of the extracted avatar body bone capable of transitioning without violating the from-to rotation angle transition definition that gives wrong impression with respect to each axis in the “relative transitionable angle of a rotation angle” of the determination value log DB table 1000.

In a case where the rotation angle of the right hand bone of the avatar transitions from 0 [degrees] to 270 [degrees] between time t1 and time t1+1, the second time-series wrong impression determining unit 1802 is to record “+40 [degrees]” in the “relative transitionable variable” in step S2206. That is, in such a case, the right hand bone of the avatar will not rotate backward, and an image giving wrong impression will not be displayed.

As is apparent from the above description, in the image generating system 100 according to the third embodiment, combination conditions (FIG. 19) that give wrong impression by combining with a from-to rotation angle transition definition that gives wrong impression defined for each avatar body bone are determined in advance. The image generating system 100 according to the third embodiment determines whether the transition of the avatar body bone between the time t1 and the time t1+1 matches the combination conditions (FIG. 19). In the image generating system 100 according to the third embodiment, when the transition of the avatar body bone does not violate the from-to rotation angle transition definition (FIG. 8) that gives wrong impression with respect to each axis, but is determined to match the conditions (FIG. 19), the image generating system 100 of the third embodiment will not reflect nonverbal behavior as it is to the transition of the avatar body bone. In this case, the image generating system 100 according to the third embodiment generates an avatar image within a range that does not give wrong impression.

As a result, the possibility of generating an image that gives wrong impression to the counterpart person who sees the avatar may be reduced. In other words, an image that provides no wrong impression to the counterpart person who sees the avatar may be generated.

### Fourth Embodiment

In the first to third embodiments, transition of each avatar body bone between time t1 and time t1+1 is determined with respect to the avatar skeleton model candidate generated based on the sensor data. In the first to third embodiments, restriction is imposed on the movement of the time series of the avatar based on the determination result on the transition of the avatar body bone to avoid generating an image giving wrong impression to other users.

In the fourth embodiment, restriction is imposed on the movement of the time series of the avatar by anticipating the presence of obstacles or the like in real space. Thus, generation of an image giving wrong impression to other users may be avoided.

For example, it is assumed that there is a desk between the depth sensor and the user in real space. Further, it is assumed that the user's hand under the desk is at a farthest possible position at which the depth sensor is able to sense the user's hand. In this case, it is assumed that the transition of the bone of the avatar's hand will frequently give wrong impression by causing the avatar body bone to transition based on the depth data.

In the related art technology, for example, a moving object is detected (a moving object such as a user is detected) from a captured image obtained in real time, and a stationary object is detected as an obstacle. However, the transition of the bone of the avatar may be affected differently between a case where the obstacle is a soft cloth and a case where the obstacle is a hard desk. Accordingly, in the fourth embodiment, an area frequently giving wrong impression when generating an avatar skeleton model candidate is specified based on the previous sensor data, and the transition of the avatar body bone is not allowed in the specified area. As a result, generation of an image giving wrong impression to other users may be avoided. In the following, the fourth embodiment will be described in detail by focusing on the differences from the first embodiment.

### Functional Configuration of Restricting Unit of Image Generating Apparatus

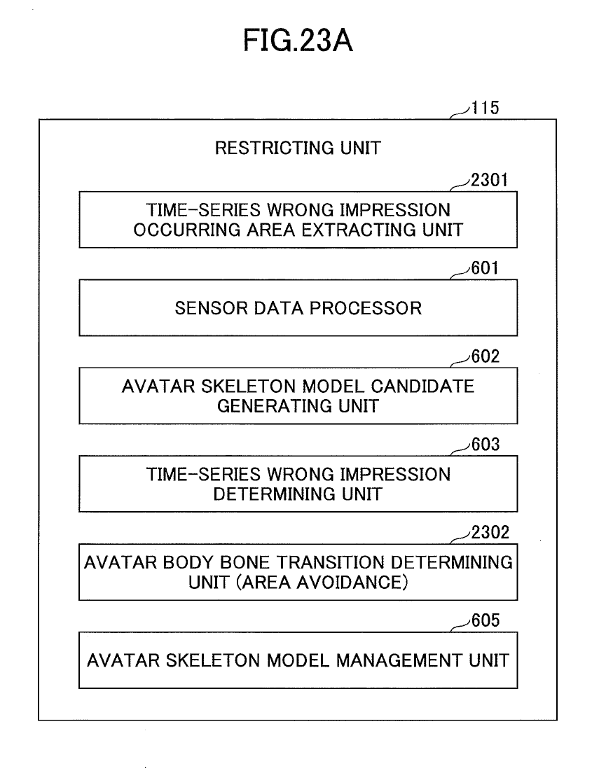

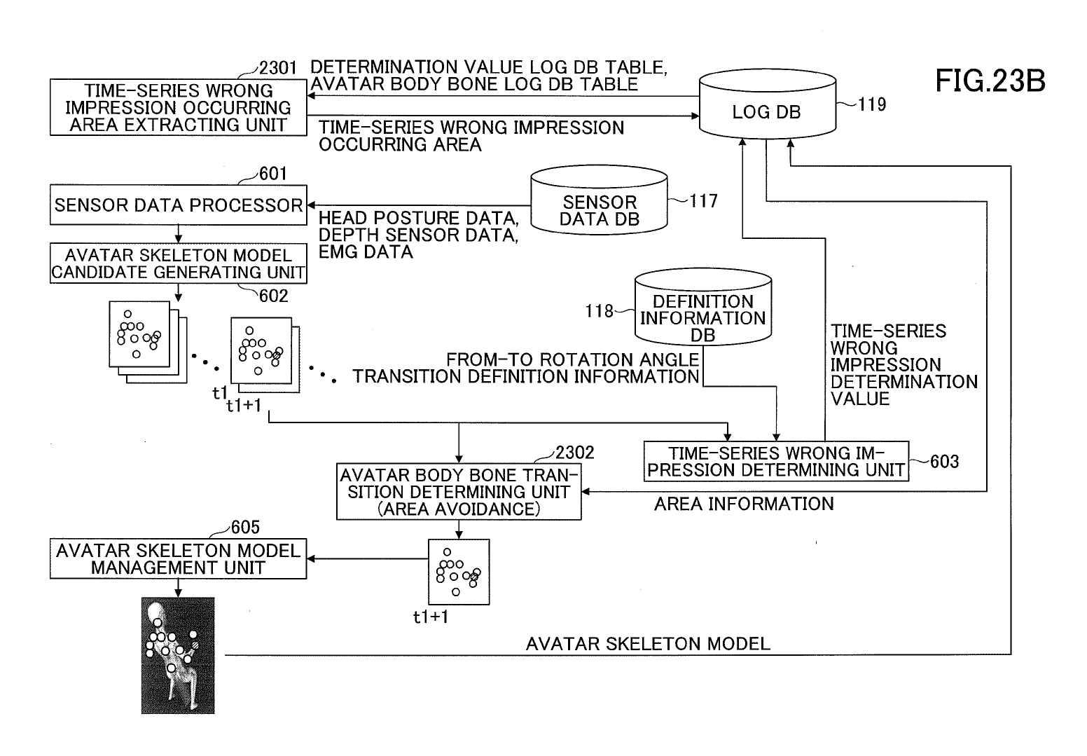

First, a description is given of a functional configuration of a restricting unit of the image generating apparatus in the fourth embodiment. FIGS. 23A and 23B are fourth diagrams illustrating a functional configuration of a restricting unit of the image generating apparatus. Of the elements illustrated in FIG. 23A, the same reference numerals are assigned to the elements having the same functions as the elements illustrated in FIG. 6A, and a description of these elements is omitted from the specification.

The difference between FIG. 6A and FIG. 23A is that in FIG. 23A, the restricting unit 115 includes a time-series wrong impression occurring area extracting unit 2301 and an avatar body bone transition determining unit (area avoidance) 2302.

As illustrated in FIG. 23B, the time-series wrong impression occurring area extracting unit 2301 generates time series wrong impression occurring area information (Hereinafter referred to as “area information”) by referring to the determination value log DB table 1000 and the avatar body bone log DB table 1100 stored in the log DB 119.

Specifically, the time-series wrong impression occurring area extracting unit 2301 extracts the “user's current time” of the log data recorded as “high” in the time series wrong impression determination value from the determination value log DB table 1000. The time-series wrong impression occurring area extracting unit 2301 refers to the avatar body bone log DB table 1100 based on the extracted “user's current time”, and determines location coordinates of the avatar transitioned before and after the extracted “user's current time”. As a result, the time-series wrong impression occurring area extracting unit 2301 is enabled to create a list of position coordinates at which the time series wrong impression determination value is “high” between time t1 and time t1+1.

The time-series wrong impression occurring area extracting unit 2301 records the created list as a “time series wrong impression occurring area” in the area information. Note that when the time-series wrong impression occurring area extracting unit 2301 records the time series wrong impression occurring area, the time-series wrong impression occurring area extracting unit 2301 records a time (start time or end time) at which the time series wrong impression occurring area is determined, the user ID of the determined log data, the information processing apparatus ID, and the like together with the time series wrong impression occurring area.

The time-series wrong impression occurring area extracting unit 2301 records an area that includes an overall time series wrong impression occurring position coordinates as a time series wrong impression occurring area. Alternatively, the time-series wrong impression occurring area extracting unit 2301 records, as a time series wrong impression occurring area, an area that includes high density areas, among the time series wrong impression occurring position coordinates. Further, the time-series wrong impression occurring area extracting unit 2301 records, for example, as a time series wrong impression occurring area, an area specified by a sphere having a radius being within a predetermined value from the center of gravity of the entire time series wrong impression occurring position coordinates.

The avatar body bone transition determining unit (area avoidance) 2302 determines a position of each avatar body bone in virtual reality space with respect to the avatar skeleton model candidate generated by the avatar skeleton model candidate generating unit 602. In addition, the avatar body bone transition determining unit (area avoidance) 2302 refers to the area information stored in the log DB 119 and determines whether the position of each avatar body bone in virtual reality space violates the time series wrong impression occurring area. To refer to the area information, the avatar body bone transition determining unit (area avoidance) 2302 refers to the corresponding user ID and the time series wrong impression occurring area associated with the information processing apparatus ID.

To refer to the area information 2400, the avatar body bone transition determining unit (area avoidance) 2302 may refer only to the time at which the time series wrong impression occurring area is determined being relatively close to the current time. For example, the avatar body bone transition determining unit (area avoidance) 2302 refers to the time series wrong impression occurring area that is determined during the previous half day.

Furthermore, when the avatar body bone transition determining unit (area avoidance) 2302 determines that the position of one of the avatar body bones in virtual reality space violates the time-series wrong impression occurring area, the avatar body bone transition determining unit (area avoidance) 2302 will not reflect the transition of the corresponding avatar body bone in the avatar skeleton model. Furthermore, when the avatar body bone transition determining unit (area avoidance) 2302 determines that the position of one of the avatar body bones in virtual reality space violates the time-series wrong impression occurring area, the avatar body bone transition determining unit (area avoidance) 2302 determines transition of the corresponding avatar so as to avoid a time-series wrong impression occurring area. Note that to determine the transition of the avatar body bone so as to avoid a time-series wrong impression occurring area, an obstacle visually invisible in the time-series wrong impression occurring area may be set in advance within the virtual reality space. Setting of a visually invisible obstacle within the virtual reality space in advance may enable the corresponding avatar body bone to steadily transition by avoiding a position of the obstacle.

### Area Information

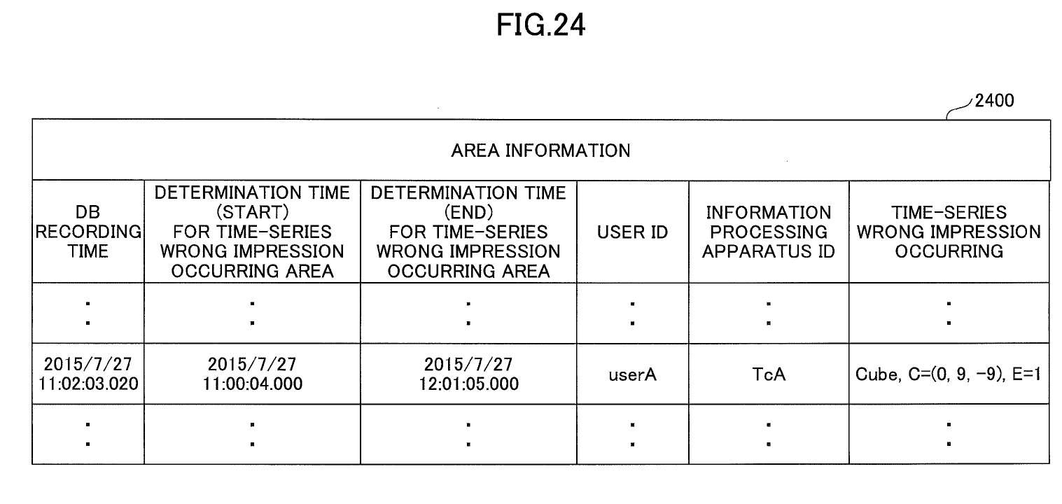

Next, a description is given of area information stored in the log DB 119. FIG. 24 is a diagram illustrating one example of area information. As illustrated in FIG. 24, area information 2400 includes “DB recording time”, “determination time (start time) at which the time series wrong impression occurring area is determined”, and “determination time (end time) at which the time series wrong impression occurring area is determined” as items of information. The area information 2400 further includes “user ID”, “information processing apparatus ID”, and “time series wrong impression occurring area” as items of information.

The “DB recording time” includes a time stamp added at a time at which the time-series wrong impression occurring area extracting unit 2301 has recorded a time-series wrong impression occurring area in the area information 2400 of the log DB 119.

The “determination time (start) at which the time series wrong impression occurring area” includes a time at which the time-series wrong impression occurring area extracting unit 2301 has started determining the time series wrong impression occurring area. The “determination time (end) at which the time series wrong impression occurring area” includes a time at which the time-series wrong impression occurring area extracting unit 2301 has ended determining the time series wrong impression occurring area.

Note that the time-series wrong impression occurring area extracting unit 2301 may determine the time series wrong impression occurring area at predetermined time intervals. Alternatively, the time series wrong impression occurring area may be determined when the number of the time-series wrong impression determination values newly recorded in the determination value log DB table 1000 reaches a predetermined amount or more. Further, the time series wrong impression occurring area may be determined when the number of avatar skeleton models newly recorded in the avatar body bone log DB table 1100 reaches a predetermined amount or more.

The “user ID” includes an identifier for identifying a user. The “information processing apparatus ID” includes an ID of an information processing apparatus.

The “time series wrong impression occurring area” includes an area having position coordinates corresponding to the time series wrong impression determination value being “high”. In the example of FIG. 24, “Cube, C=(0, 9, −9), E=1” indicates an area of a cube with a side length of 1 and coordinates of the center of gravity position being (0, 9, −9) in virtual reality space.

As is apparent from the above description, the image generating system 100 in the fourth embodiment specifies an area in virtual reality space in which the time series wrong impression determination value is “high”, and avoids transition of the avatar body bone to the specified area.

As a result, it is possible to avoid generating an image that gives wrong impression to the counterpart person who sees the avatar. In other words, an image that provides no wrong impression to the counterpart person who sees the avatar may be generated.

### Fifth Embodiment

In the first embodiment described above, the from-to rotation angle transition definition information 800 has been described as being defined in advance by the administrator or the like. In a fifth embodiment, the from-to rotation angle transition definition information 800 is sequentially updated by analyzing the avatar body bone log DB table 1100 stored in the log DB 119. The following describes details of the fifth embodiment.

### Overall Configuration of Image Generating System

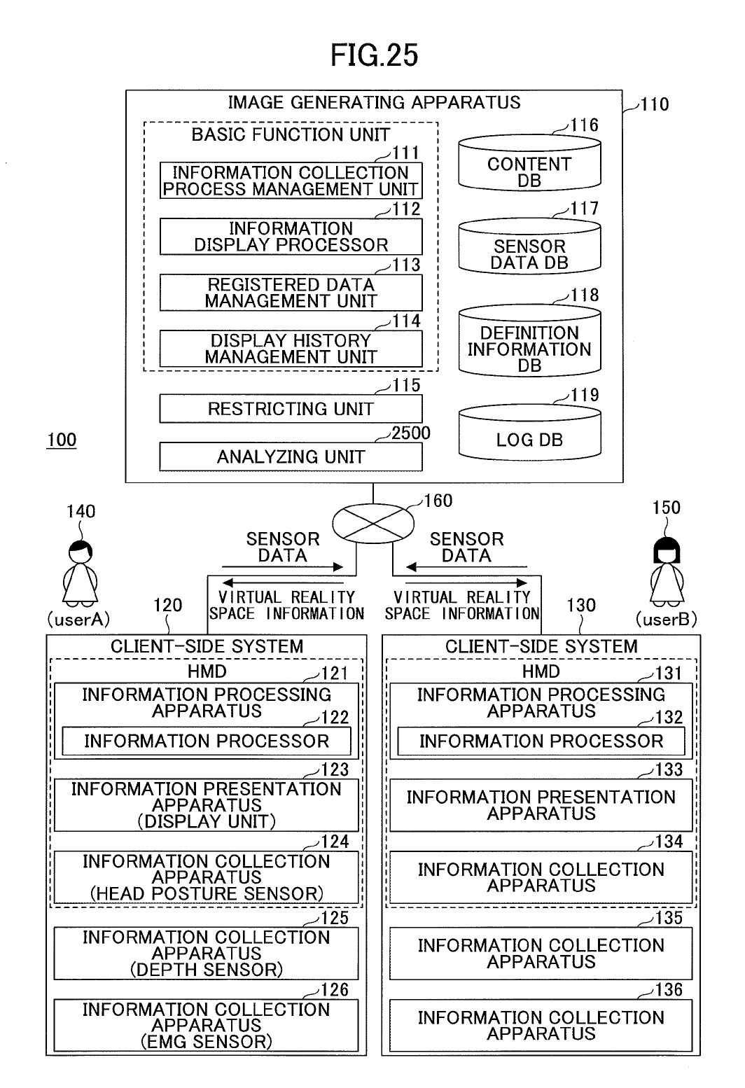

First, a description is given of an image generating system in the fifth embodiment. FIG. 25 is a second diagram illustrating an example of an overall configuration of an image generating system. The difference from the image generating system 100 illustrated in FIG. 1 is that, in a case of the image generating system 100 illustrated in FIG. 25, the image generating apparatus 110 includes an analyzer 2500.

The analyzer 2500 is configured to analyze the avatar body bone log DB table 1100 when the avatar body bone log DB table 1100 is updated by operating the basic function unit and the restricting unit 115 and providing a communication service.

The analyzer 2500 updates the from-to rotation angle transition definition information 800 stored in the definition information DB 118 based on an analysis result.

### Example of Analysis Result

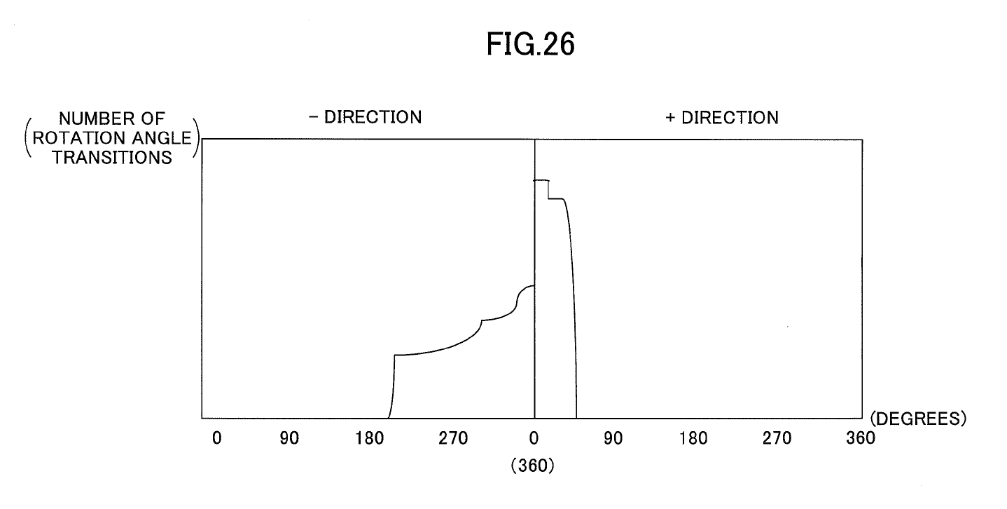

FIG. 26 is a diagram illustrating an example of an analysis result by the analyzer 2500, which indicates a result of analyzing a occurrence frequency of from-to rotation angle transitions of the avatar's right hand bone in a predetermined time period. In FIG. 26, a horizontal axis represents a rotation angle with respect to an X axis, and a vertical axis represents the number of rotation angle transitions.

According to the example of FIG. 26, in a + direction, the transition occurrence frequency is high between 0 [degrees] and 45 [degrees], and in a − direction, the transition occurrence frequency is high between 360 [degrees] and 210 [degrees].

That is, the occurrence frequency is low in the from-to rotation angle transition between 45 [degrees] and 210 [degrees]. Note that the analyzer 2500 may use a threshold obtained from the number of rotation angle transitions when determining whether the occurrence frequency is low, or may use a threshold obtained from a histogram of occurrence frequency values.

### Functional Configuration of Analyzer of Image Generating Apparatus

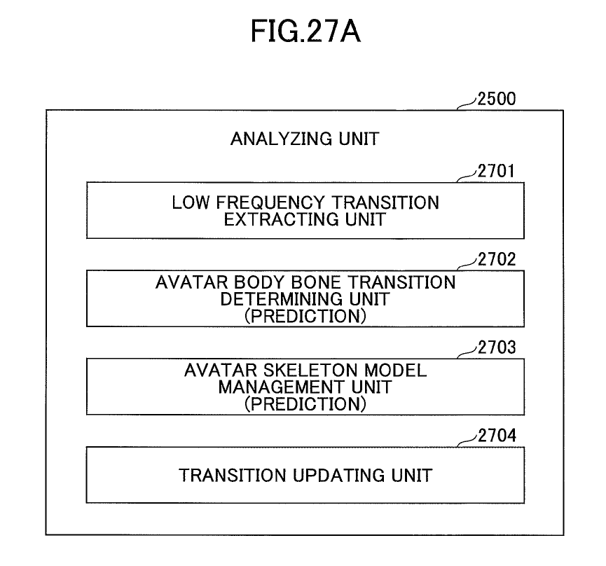

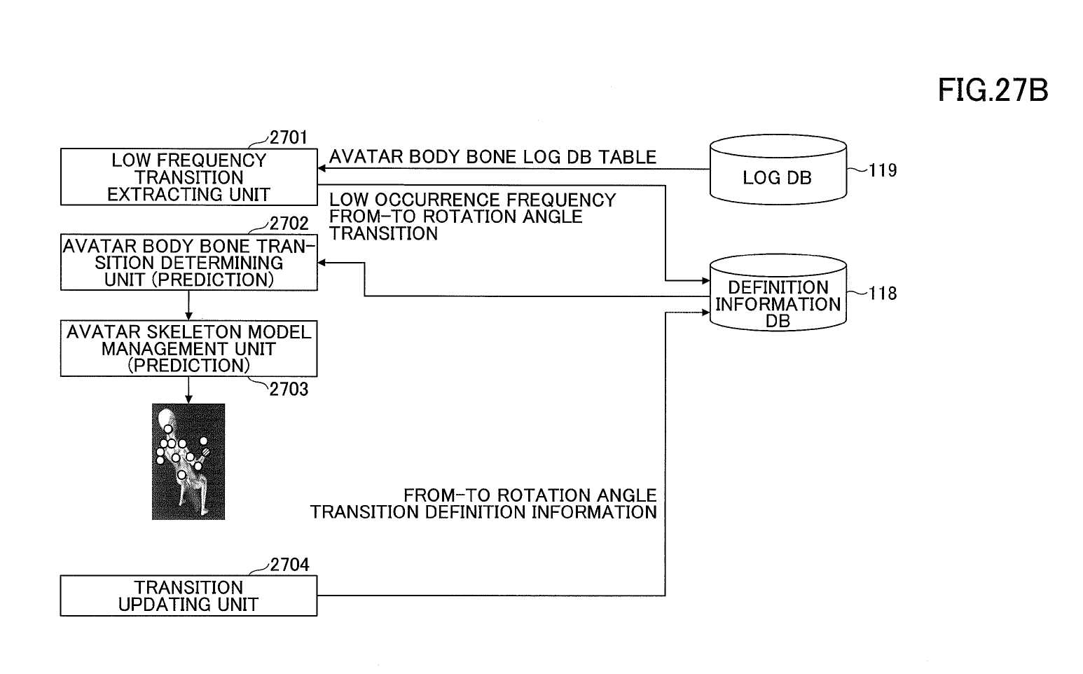

The following illustrates a functional configuration of the analyzer 2500. FIGS. 27A and 27B are diagrams illustrating an example of a functional configuration of the analyzer 2500. As illustrated in FIGS. 27A and 27B, the analyzer 2500 has a low frequency transition extracting unit 2701, an avatar body bone transition determining unit (prediction) 2702, an avatar skeleton model management unit (prediction) 2703, and a transition updating unit 2704.

The low frequency transition extracting unit 2701 reads a “angle of rotation angle transition” of the avatar body bone log DB table 1100 stored in the log DB 119 and makes an histogram using occurrence frequency regarding from-to rotation angle transition of each avatar body bone. Furthermore, the low frequency transition extracting unit 2701 investigates from-to rotation angle transition of the avatar body bone in low occurrence frequency based on the obtained histogram.

In the “angle of rotation angle transition” of the avatar body bone log DB table 1100, transitions of avatar body bones for all users in all time periods are recorded. The low frequency transition extracting unit 2701 reads data of the “angle of rotation angle transition” in a predetermined time period from the recorded transitions of avatar body bones for all users in all time periods (e.g., data of “angle of rotation angle transition” of the avatar's right hand bone in the previous one hour), and makes an histogram using the occurrence frequency of the from-to rotation angle transition of each avatar body bone. The low frequency transition extracting unit 2701 reads data of “angle of rotation angle transition”, not data of “displayed avatar skeleton model” of the avatar body bone log DB table 1100. The reason why the angle of rotation angle transition is used is as follows. When the time series wrong impression determination value is determined to be “medium” or “high”, but the avatar body bone has changed its rotation angle transition, the shortest transition is not necessarily determined to be the transition of the avatar body bone at time t1+1. Hence, the analysis will be conducted based on an actual result of the transition. The low frequency transition extracting unit 2701 reads the data of “angle of rotation angle transition” that records the number of rotation angle transitions of one of plus (+) and minus (−) signs to investigate from-to rotation angle transition of the avatar body bone in low occurrence frequency.

The avatar body bone transition determining unit (prediction) 2702 generates movements of the avatar skeleton model having time-series that are expected to give wrong impression and movements of the avatar skeleton model having time-series that are expected not to give wrong impression with respect to the from-to rotation angle transition of the avatar body bone in low occurrence frequency extracted by the low frequency transition extracting unit 2701.

For example, it is assumed that 45 [degrees] to 210 [degrees] are extracted as the from-to rotation angle transition of the avatar body bone in low occurrence frequency. In this case, the avatar body bone transition determining unit (prediction) 2702 generates a movement of the avatar skeleton model having time-series that is expected to give wrong impression and a movement of the avatar skeleton model having time-series that is expected not to give wrong impression in both the + and − directions. Specifically, the avatar body bone transition determining unit (prediction) 2702 generates a movement of a rotation of the avatar's right hand bone with respect to the X axis in a + direction of 45 [degrees] to 210 [degrees] and a movement of a rotation of the avatar's right hand bone with respect to the X axis in a − direction 210 [degrees] to 45 [degrees].

Note that according to the from-to rotation angle transition definition information 800, “40<X<220” is defined as “a from-to rotation angle transition definition (rotation with respect to the X axis) that gives wrong impression” with respect to the avatar's right hand bone. Accordingly, the movement of the avatar's right hand bone generated by the avatar body bone transition determining unit (prediction) 2702 and expected to give wrong impression is already included in the range defined in advance in the from-to rotation angle transition definition information 800.

In this case, the avatar body bone transition determining unit (prediction) 2702 generates a movement from 40 degrees to 45 degrees in a + direction and a movement from 220 [degrees] to 210 [degrees] in a − direction as the movements of the avatar's right hand bone that are expected not to give wrong impression.

The avatar skeleton model management unit (prediction) 2703 displays transitions of the avatar body bone generated by the avatar body bone transition determining unit (prediction) 2702. Specifically, the avatar skeleton model management unit (prediction) 2703 displays relative transitionable angle of rotation angle of the avatar body bone described below as the transitions of the avatar body bone generated by the avatar body bone transition determining unit (prediction) 2702.

Avatar body bone movement expected to give no wrong impression in a + direction of the X axis
Avatar body bone movement expected to give wrong impression in a + direction of the X axis
Avatar body bone movement expected to give no wrong impression in a − direction of the X axis
Avatar body bone movement expected to give wrong impression in a − direction of the X axis
The low frequency transition extracting unit 2701 performs similar processes on a Y axis or a Z axis when from-to rotation angle transition with respect to the Y axis or the Z axis is extracted as from-to rotation angle transition of the avatar body bone in low occurrence frequency.

When a user determines whether the movement of the avatar body bone displayed by the avatar skeleton model management unit (prediction) 2703 gives wrong impression, the a transition updating unit 2704 acquires a determination result. The transition updating unit 2704 updates the “from-to rotation angle transition definition that gives wrong impression” with respect to the from-to rotation angle transition definition information 800 based on the user's determination result of giving or not giving wrong impression.

Note that the user indicated in the above may be an administrator who manages the image generating apparatus 110 or users 140 and 150 who use the image generating system 100. Alternatively, in a case of the user indicated above using the image generating system 100, the user may be either one user or multiple users. Furthermore, in a case of multiple users, the determination result of giving or not giving wrong impression may be determined by performing a majority vote process or by performing an averaging process to update the “from-to rotation angle transition definition that gives wrong impression” based on the determination result.

Note that the determination result of the user(s) may, for example, indicate that no wrong impression is given to the transition of the avatar body bone of 40 [degrees] to 45 [degrees] and the transition of the avatar body bone of 0 [degrees] to 45 [degrees] in a + direction. Further, the determination result of the user(s) may, for example, indicate that wrong impression is given to the transition of the avatar body bone of 220 [degrees] to 210 [degrees] and the transition of the avatar body bone of 360 [degrees] to 210 [degrees] in a − direction. Alternatively, in addition to the transition of the avatar body bone of 40 [degrees] to 45 [degrees] or 220 [degrees] to 210 [degrees], a longer transition of the avatar body bone including the transition of the avatar body bone of 40 [degrees] to 45 [degrees] or 220 [degrees] to 210 [degrees] may be presented to the user(s) to help the users' determination. Alternatively, there may be a mode of presenting, to the users, a transition of multiple avatar body bones including from-to rotation angle transition to be checked in order to verify whether the users accurately determine whether to give or not to give wrong impression.

In this case, the transition updating unit 2704 updates the from-to rotation angle transition definition (rotation with respect to the X axis) giving wrong impression in the from-to rotation angle transition definition information 800 from “40<X<220” to “45<X<220”.

Note that the transition updating unit 2704 may update not only the from-to rotation angle transition definition information 800 but may also update combination condition definition information 1900.

As is apparent from the above description, the image generating system 100 according to the fifth embodiment analyzes the avatar body bone log DB table 1100 stored in the log DB 119 by providing a communication service. In addition, the image generating system 100 according to the fifth embodiment updates the from-to rotation angle transition definition information 800 according to the analysis result. Accordingly, a movement giving wrong impression varies with a time period during which the image generating system 100 is used, an environment in which the client-side system is installed, or the like.

Note that the from-to rotation angle transition definition information 800, from-to rotation angle transition combination condition information 1800 and the like that give wrong impression may be managed for each user, for each client system, and for each client application.

The disclosed embodiments may be enabled to generate an image that provides no wrong impression to a counterpart person who sees an avatar.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. An image generating apparatus comprising:
a memory; and
one or more processors programed to execute a process including
acquiring first data indicating a position of a body part of a predetermined person obtained as a result of sensing the predetermined person at a first timing;
generating a first image having the position of the body part of the predetermined person indicated by the first data reflected in an avatar representing the predetermined person;
acquiring second data indicating a position of the body part of the predetermined person obtained as a result of sensing the predetermined person at a second timing after the first timing;
determining whether to reflect the position of the body part of the predetermined person indicated by the second data in the avatar representing the predetermined person according to a change in movement of the predetermined person from the first data to the second data; and
outputting, instead of the first image, a second image having the position of the body part of the predetermined person indicated by the second data reflected in the avatar representing the predetermined person when it is determined to reflect the position of the body part of the predetermined person indicated by the second data in the avatar representing the predetermined person.

2. The image generating apparatus according to claim 1, wherein
the outputting includes continuously outputting the first image having the position of the body part of the predetermined person indicated by the first data reflected in the avatar representing the predetermined person when it is determined not to have the position of the body part of the predetermined person indicated by the second data reflected in the avatar representing the predetermined person.

3. The image generating apparatus according to claim 1, the process further comprising:
calculating third data using the first data and the second data when it is determined not to have the position of the body part of the predetermined person indicated by the second data reflected in the avatar representing the predetermined person, wherein
the outputting includes outputting, instead of the first image, a third image having the position of the body part of the predetermined person indicated by the third data reflected in the avatar representing the predetermined person when it is determined not to have the position of the body part of the predetermined person indicated by the second data reflected in the avatar representing the predetermined person.

4. The image generating apparatus according to claim 1, wherein
the generating includes generating the first image having the position of the body part of the predetermined person indicated by the first data reflected in the avatar representing the predetermined person and the second image having the position of the body part of the predetermined person indicated by the second data reflected in the avatar representing the predetermined person, and
the determining includes determining whether to output the second image instead of the first image according to a change from the first image to the second image.

5. The image generating apparatus according to claim 4, wherein
the determining includes determining whether to reflect the position of the body part of the predetermined person indicated by the second data in the avatar representing the predetermined person according to whether the change from the first image to the second image satisfies a predetermined condition.

6. The image generating apparatus according to claim 5, the process further comprising:
storing a type of behavior in association with one of an approach tendency and an avoidance tendency, wherein the determining includes determining to have the position of the body part of the predetermined person indicated by the second data reflected in the avatar representing the predetermined person when a behavior of the predetermined person at the first timing and a behavior of the predetermined person at the second timing are both in association with the approach tendency with respect to another person, or when the behavior of the predetermined person at the first timing and the behavior of the predetermined person at the second timing are both in association with the avoidance tendency with respect to another person.

7. The image generating apparatus according to claim 5, wherein
the determining includes determining whether to reflect the position of the body part of the predetermined person indicated by the second data in the avatar representing the predetermined person according to whether a change in movement of the predetermined person from the first data to the second data violates a predetermined section, and
the predetermined section is updated by analyzing a section in which the change in movement of the predetermined person is unlikely to occur.

8. A non-transitory computer-readable storage medium having stored therein an image generating program, which when processed by one or more processors, causes a computer to execute a process, the process comprising:
acquiring first data indicating a position of a body part of a predetermined person obtained as a result of sensing the predetermined person at a first timing;
generating a first image having the position of the body part of the predetermined person indicated by the first data reflected in an avatar representing the predetermined person;
acquiring second data indicating a position of the body part of the predetermined person obtained as a result of sensing the predetermined person at a second timing after the first timing;
determining whether to reflect the position of the body part of the predetermined person indicated by the second data in the avatar representing the predetermined person according to a change in movement of the predetermined person from the first data to the second data; and
outputting, instead of the first image, a second image having the position of the body part of the predetermined person indicated by the second data reflected in the avatar representing the predetermined person when it is determined to reflect the position of the body part of the predetermined person indicated by the second data in the avatar representing the predetermined person.

9. An image generating method executed by a computer, the image generating method comprising:
acquiring first data indicating a position of a body part of a predetermined person obtained as a result of sensing the predetermined person at a first timing;
generating a first image having the position of the body part of the predetermined person indicated by the first data reflected in an avatar representing the predetermined person;
acquiring second data indicating a position of the body part of the predetermined person obtained as a result of sensing the predetermined person at a second timing after the first timing;
determining whether to reflect the position of the body part of the predetermined person indicated by the second data in the avatar representing the predetermined person according to a change in movement of the predetermined person from the first data to the second data; and
outputting, instead of the first image, a second image having the position of the body part of the predetermined person indicated by the second data reflected in the avatar representing the predetermined person when it is determined to reflect the position of the body part of the predetermined person indicated by the second data in the avatar representing the predetermined person.
